(19) United States
(12) Patent Application Publication
(10) Pub. No.: US 2016/0321948 A1
(43) Pub. Date: Nov. 3, 2016

(54) CONTENT PROVISION SUPPORT METHOD FOR SUPPORTING PROVISION OF CONTENT WITH WHICH A MORE SUITABLE TRAINING EFFECT IS EXHIBITED

(71) Applicant: Panasonic Intellectual Property Management Co., Ltd., Osaka (JP)

(72) Inventors: YUKA ADHIKARI, Osaka (JP); KENTARO NAKAI, Hyogo (JP); TOSHIHIRO SOTA, Osaka (JP)

(21) Appl. No.: 15/088,287

(22) Filed: Apr. 1, 2016

(30) Foreign Application Priority Data
Apr. 28, 2015 (JP) 2015-092399

(51) Int. Cl. G09B 19/00; A63B 24/00; H04N 21/61; G09B 5/06

(52) U.S. Cl. CPC G09B 19/0038; G09B 5/065; A63B 24/0062; H04N 21/6125; A63B 2230/06; A63B 2230/30

(57) ABSTRACT

A method used in a training system, including presenting content provided by a trainer to a trainee, acquiring an implemented amount of a training implemented by the trainee in accordance with the presented content, acquiring an effect amount indicating change in the body of the trainee caused by the training, generating instruction information indicating new content to be provided by the trainer using the implemented amount and the effect amount, and outputting the generated instruction information.

### BACKGROUND

1. Technical Field

The present disclosure relates to a content provision support method and a server device.

2. Description of the Related Art

Online training systems have been developed for a trainee to train at his or her own home or the like on the basis of a training menu that is provided from a trainer via the Internet. When such a system is employed, the trainer appropriately creates and provides content to be used for training. The work to create the content to be used for the training requires time and labor for the trainer.

To date, a technique has been disclosed with which the workload of the trainer is reduced by a training menu being automatically altered in accordance with the implementation rate or the implementation time of the training (Japanese Unexamined Patent Application Publication No. 2013-70843).

### SUMMARY

However, in a case where the training effect of the content created by the trainer was low, the trainer has to create separate content once again, which is inefficient. Furthermore, in such a case, the utilization efficiency of resources such as a storage device in the online training system is not satisfactory.

Thus, one non-limiting and exemplary embodiment provides a content provision support method for having a trainer create content with which a more suitable training effect is exhibited.

In one general aspect, the techniques disclosed here feature a method used in a training system. The method including, presenting content provided by a trainer to a trainee, acquiring an implemented amount of a training implemented by the trainee in accordance with the presented content, acquiring an effect amount indicating change in the body of the trainee caused by the training, generating instruction information indicating new content to be provided by the trainer using the implemented amount and the effect amount, and outputting the generated instruction information.

It should be noted that these comprehensive or specific aspects may be realized by a system, a method, an integrated circuit, a computer program, or a recording medium such as a computer-readable CD-ROM, and may be realized by an arbitrary combination of a system, a method, an integrated circuit, a computer program, and a recording medium.

According to the present disclosure, it is possible to have a trainer create content with which a more suitable training effect is exhibited.

It should be noted that further effects and advantages of the present disclosure will become apparent from the details disclosed in the present specification and drawings. Such further effects and advantages may be individually provided by the various embodiments and features disclosed in the present specification and drawings, and it is also not necessarily essential that all of the effects and advantages be provided.

### BRIEF DESCRIPTION OF THE DRAWINGS

FIG. 1A is a drawing depicting an overall view of a service provided by an online training system in the present embodiment;

FIG. 1B is a drawing depicting an example in which an equipment manufacturer corresponds to a data center operating company in the present embodiment;

FIG. 1C is a drawing depicting an example in which both or either one of the equipment manufacturer and a management company corresponds to a data center operating company in the present embodiment;

FIG. 2 is a block diagram depicting an example of a configuration of the online training system;

FIG. 3 is a drawing depicting an example in which member information is schematically depicted;

FIG. 4 is a drawing depicting an example in which member information is schematically depicted;

FIG. 5 is a drawing depicting an example in which video metadata information is schematically depicted;

FIG. 6 is a drawing depicting an example in which a personal training menu is schematically depicted;

FIG. 7A is a drawing depicting an example of a user selection screen from among screens through which a trainer inputs personal training;

FIG. 7B is a drawing depicting an example of a personal training menu creation screen from among screens through which the trainer inputs personal training;

FIG. 8A is a drawing depicting an example of a personal training menu screen from among screens through which the user implements personal training;

FIG. 8B is a drawing depicting an example of a content playback screen from among screens through which the user implements personal training;

FIG. 9A is a drawing depicting an example in which training histories are schematically depicted;

FIG. 9B is a drawing depicting an example in which training histories are schematically depicted;

FIG. 9C is a drawing depicting an example in which training histories are schematically depicted;

FIG. 10A is a drawing depicting an example in which sensor data is schematically depicted;

FIG. 10B is a drawing depicting an example in which sensor data is schematically depicted;

FIG. 10C is a drawing depicting an example in which sensor data is schematically depicted;

FIG. 11 is a flowchart depicting an example of a personal training menu update procedure;

FIG. 12 is a flowchart depicting an example of a detailed procedure for categorizing content;

FIG. 13 is a drawing depicting an example of a content categorizing table;

FIG. 14 is a flowchart depicting an example of a personal training implementation status acquisition procedure;

FIG. 15A is a drawing depicting an example of a personal training implementation status table;

FIG. 15B is a drawing depicting an example of a personal training implementation status table;

FIG. 15C is a drawing depicting an example of a personal training implementation status table;

FIG. 16 is a flowchart depicting an example of a personal training effect status acquisition procedure;

FIG. 17A is a drawing depicting an example of an effect level mapping table for an amount of increase/decrease in body weight;

FIG. 17B is a drawing depicting an example of an effect level mapping table for an amount of increase/decrease in muscle mass;

FIG. 18A is a drawing depicting an example of a personal training implementation status table;

FIG. 18B is a drawing depicting an example of a personal training implementation status table;

FIG. 18C is a drawing depicting an example of a personal training implementation status table;

FIG. 19 is a flowchart depicting an example of a detailed procedure for calculating content demand;

FIG. 20 is a drawing depicting an example of a content categorizing table;

FIG. 21 is a drawing depicting an example of a content categorizing table;

FIG. 22 is a flowchart depicting an example of a detailed procedure for altering a personal training menu;

FIG. 23 is a drawing depicting an example in which a personal training menu is schematically depicted;

FIG. 24 is a drawing depicting an example in which video metadata information is schematically depicted;

FIG. 25 is a drawing depicting an overall view of a service provided by an online coaching system of a service type 1 (in-company data center type of cloud service);

FIG. 26 is a drawing depicting an overall view of a service provided by an online coaching system of a service type 2 (IaaS utilizing type of cloud service);

FIG. 27 is a drawing depicting an overall view of a service provided by an online coaching system of a service type 3 (PaaS utilizing type of cloud service); and

FIG. 28 is a drawing depicting an overall view of a service provided by an online coaching system of a service type 4 (SaaS utilizing type of cloud service).

### DETAILED DESCRIPTION

### Findings Forming the Basis for the Present Disclosure

There are online training systems that present training menus via the Internet for trainees who are not able to visit a store to receive training. When an online training system is employed, a trainer creates a training menu suitable for each trainee and notifies the trainee via this system. The trainee, at his or her own home or the like, implements training by playing content notified as a training menu at a time convenient for the trainee. In order for the trainee to continue training in an effective manner without losing interest, the trainer additionally creates content to be used as a training menu on a regular or non-regular basis.

Generally, in an online training system, one trainer manages the training of a large number of trainees compared to a training system in which a trainee visits a store. Therefore, it is necessary for the trainer to create a training menu that is suitable for each trainee and to create new content, and thus there is a problem in that the workload for the trainer is considerable.

However, in a case where the training effect of the content created by the trainer has been low, the trainer has to create separate content once again, which is inefficient. Furthermore, in such a case, the utilization efficiency of resources such as a storage device in the online training system is not satisfactory.

For example, assuming that training efficiency is calculated according to a numerical formula (training effect/storage capacity), in a case where a lot of content having a comparatively small training effect is stored in a storage device, the training efficiency becomes a low value compared to a case where content having a comparatively large training effect is stored.

Thus, when a training menu is updated in the online training system, it is desirable for it to be detected that there is no content suitable for the trainee, and for content that should be newly created and added to be analyzed and notified to the trainer. However, to date, a technical solution has not been studied for detecting content such as the aforementioned or analyzing and notifying the content.

In this way, with the past technique, it is not possible to suitably handle a situation where a training menu suitable for a trainee cannot be created due to there being no content that is suitable for the trainee or there being a shortage thereof.

A content provision support method according to an aspect of the present disclosure is a method used in a training system, comprising: presenting content provided by a trainer to a trainee; acquiring an implemented amount of a training implemented by the trainee in accordance with the presented content; acquiring an effect amount indicating change in a body of the trainee caused by the training; generating instruction information indicating new content to be provided by the trainer using the implemented amount and the effect amount; and outputting the generated instruction information.

Accordingly, in the training system, instruction information indicating content presumed to be in shortage is generated when a training menu is altered. It is sufficient for the trainer to additionally create and provide only content that is required by the trainee, and therefore the burden of generating content can be reduced. Furthermore, for the trainee, since required content is added and provided as a training menu as appropriate, a more suitable training menu can be received.

Furthermore, by additionally generating and providing only content required by the trainee, an effect is also obtained in that the amount of content to be retained by the training system can be reduced, and the utilization efficiency of resources such as the storage capacity of the training system is improved.

For example, the content is linked with the level of the training to be implemented based on the content, in the generating, the implemented amount and the effect amount are used to decide the level of the training that is based on the new content, and the instruction information includes the decided level.

Accordingly, in the training system, information is generated that indicates content presumed to be in shortage and also the level of such content. The trainer can create and provide suitable content as a result of being notified of that level.

For example, the method may comprise calculating a degree of demand for the new content using the implemented amount and the effect amount, wherein the instruction information includes the degree of demand for the new content.

Accordingly, in the training system, a degree of demand that indicates the degree to which content presumed to be in shortage is required is generated. The trainer can create and provide suitable content as a result of being notified of that degree of demand.

For example, the method may comprise, storing a plurality of items of the content provided by the trainer is retained in the training system, and calculating the degree of demand for each of the stored content by increasing the degree of demand for content of training that is the same level as training based on the content in question in a case where (a) the implemented amount of the training based on the content in question is less than a prescribed value, (b) the training system does not possess content of training that is the same level as the training based on the content in question and that has been implemented in an amount equal to or greater than a prescribed threshold value, and (c) the training system does not possess content of training that is the same level as the training based on the content in question and that has not yet been implemented by the trainee.

Accordingly, in the training system, the degree of demand can be calculated in a more specific manner using the implemented amount.

For example, the method may comprise, storing a plurality of items of the content provided by the trainer in the training system, and calculating the degree of demand for each of the stored content by increasing the degree of demand for content of a higher level than training based on the content in question in a case where (a) the implemented amount of the training based on the content in question is equal to or greater than a prescribed value, (b) it is determined that the acquired effect amount satisfies a condition indicating that a prescribed effect is exhibited in the body of the trainee due to the training based on the content in question, (c) the training system does not possess content of training that is of the higher level and has been implemented in an amount equal to or greater than a prescribed threshold value, and (d) the training system does not possess content of training that is of the higher level and has not yet been implemented by the trainee.

Accordingly, in the training system, the degree of demand can be calculated in a more specific manner using the implemented amount and the effect amount.

For example, the content is linked with the category of the training implemented based on the content, in the calculating, the plurality of items of content is grouped according to the category and level of the training based on the content in question, and the training of the higher level for when the degree of demand is calculated is training of the same category as the training based on the content in question.

Accordingly, in the training system, information indicating content presumed to be in shortage is generated by managing content in group units and specifying a group presumed to be in shortage.

For example, the method may comprise, storing the content provided by the trainer, acquiring and storing the new content provided by the trainer in accordance with the output instruction information, selecting content using the implemented amount and the effect amount from among the stored content and the stored new content, and presenting a menu indicating the selected content to the trainee.

Accordingly, in the training system, content for allowing the trainee to implement training is selected based on retained content, which includes content newly provided by the trainer. Thus, content that is suitable for the trainee is provided to the trainee.

Furthermore, a server device according to an aspect of the present disclosure is a server device in a training system including: one or more memories; and circuitry which, in operation: presents content provided by a trainer to a trainee; acquires an implemented amount of a training implemented by the trainee in accordance with the presented content; acquires an effect amount indicating change in the body of the trainee caused by the training; generates instruction information indicating new content to be provided by the trainer using the implemented amount and the effect amount; and outputs the generated instruction information.

It should be noted that these comprehensive or specific aspects may be realized by a system, a method, an integrated circuit, a computer program, or a recording medium such as a computer-readable CD-ROM, and may be realized by an arbitrary combination of a system, a method, an integrated circuit, a computer program, or a recording medium.

Hereinafter, embodiments will be described in a specific manner with reference to the drawings.

It should be noted that the embodiments described hereinafter all represent comprehensive or specific examples. The numerical values, the shapes, the materials, the constituent elements, the arrangement positions and modes of connection of the constituent elements, the steps, the order of the steps, and the like given in the following embodiments are examples and are not intended to limit the present disclosure. Furthermore, constituent elements that are not described in the independent claims indicating the most significant concepts from among the constituent elements in the following embodiments are described as optional constituent elements.

### (Overall View of Service Provided)

First, an overall view of a service provided by an online training system in the present embodiment will be described.

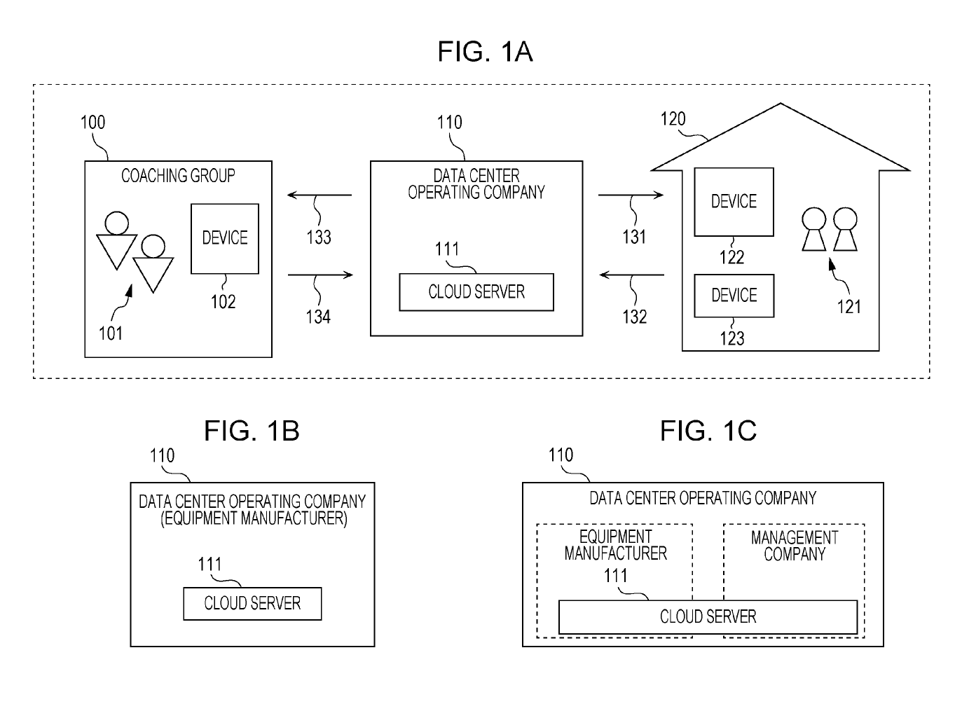

FIG. 1A is a drawing depicting an overall view of the service provided by the online training system in the present embodiment. The online training system includes a coaching group 100, a data center operating company 110, and a trainee group 120. There is one or more coaching group 100. Furthermore, there is one or more trainee group 120.

The coaching group 100 is a corporation, an association, or a sole proprietorship such as a fitness club, and the scale thereof is not significant. One or more trainers 101 belong to the coaching group 100. The trainers 101 own one or more devices 102. The plurality of devices 102 includes devices that are able to connect to the Internet (a smartphone, a tablet, a personal computer (PC), a television, or the like). The plurality of devices 102 may include devices that are not able to connect to the Internet alone but are able to connect to the Internet via a home gateway (not depicted).

The trainee group 120 is a corporation, an association, a household, or the like, and the scale thereof is not significant. One or more trainees 121 belong to the trainee group 120. The trainees 121 own one or more devices 122 and devices 123. The devices 122 include devices that are able to connect to the Internet (a smartphone, a tablet, a personal computer (PC), a television, or the like).

Furthermore, the devices 123 include devices capable of measuring vital data, namely information relating to the bodies of the trainees 121 (a body measurement device such as a weighing machine, a body composition meter, an activity meter, a blood pressure meter, or a heart rate meter). The devices 123 may include devices that are not able to connect to the Internet alone but are able to connect to the Internet via the devices 122 or a home gateway (not depicted).

The data center operating company 110 is provided with a cloud server 111. The cloud server 111 is a virtual server that cooperates with various devices via the Internet. The cloud server 111 manages large data (big data) that is difficult to handle mainly with normal database management tools or the like. The data center operating company 110, for example, manages data, manages the cloud server 111, and operates a data center that implements the aforementioned. Details of the service performed by the data center operating company 110 are described later on.

It should be noted that the server managed by the data center operating company 110 is not limited to a virtual server. The server may be a computer physically provided with an external storage device such as a CPU, a memory, or a HDD, and may be a personal computer.

Here, the data center operating company 110 is not limited to a company that only manages data or the cloud server 111. For example, the equipment manufacturer corresponds to the data center operating company 110 in a case where an equipment manufacturer, which develops or manufactures one device from among the plurality of devices 122 or the like, manages data, the cloud server 111, or the like as depicted in FIG. 1B. Furthermore, the data center operating company 110 is not limited to one company. For example, both or either one of the equipment manufacturer and the management company correspond to the data center operating company 110 in a case where an equipment manufacturer and a management company are managing data or managing the cloud server 111 on a joint or shared basis as depicted in FIG. 1C.

Next, the flow of information in the aforementioned online training system will be described.

First, the trainee 121 uses his or her own device 122 to acquire data from the cloud server 111 of the data center operating company 110 and display an application screen on the device 122 (arrows 131 and 132). The trainee 121 inputs member information on the application screen. Data input by the trainee 121 on the device 122 is managed on the cloud server (arrow 132). It is assumed that registration of the member information is performed when enrolling in the online training service.

Next, the trainer 101 uses his or her own device 102 to acquire data from the cloud server 111 of the data center operating company 110 and display an application screen on the device 102 (arrows 133 and 134). The trainer 101 refers to the member information or the like on the device 102, and performs an operation for creating a personal training menu that is suitable for the trainee 121. Data input by the trainer 101 on the device 102 is managed on the cloud server (arrow 134).

Next, the trainee 121 uses his or her own device 122 to acquire data from the cloud server 111 of the data center operating company 110 and display an application screen on the device 122 (arrows 131 and 132). The trainee 121 displays, on the device 122, the personal training menu input by the trainer 101, and selects and views content (a video) from the presented menu. The content is distributed by the cloud server 111 (arrow 131).

Viewing history data is transmitted to the cloud server 111 (arrow 132) when the trainee 121 views the content. Furthermore, the trainee 121 uses the device 123 to measure his or her own vital data, which is transmitted to the cloud server (arrow 132). It should be noted that cloud server access history and application operation history may be saved in the cloud server in order for the trainee 121 to use the online training service (arrow 132).

Next, the trainer 101 uses his or her own device 102 to acquire data from the cloud server 111 of the data center operating company 110 and display an application screen on the device 102 (arrows 133 and 134). Content demand calculated from the personal training menus, training history, and sensor data of all trainees managed by the cloud server 111 is displayed on the application screen. When the trainer 101 additionally produces training content on the basis of the displayed content demand, the content is registered in the cloud server 111 from the application screen (arrow 134).

### Embodiment 1

Embodiment 1 relates to a technique for, in an online training service, presenting a trainer with content to be additionally produced from the implementation status and effect status of a trainee who is implementing online training. Although an example case is described with the content being video content in which training details are depicted as a video, it should be noted that the content may be text content in which training details are indicated by character information.

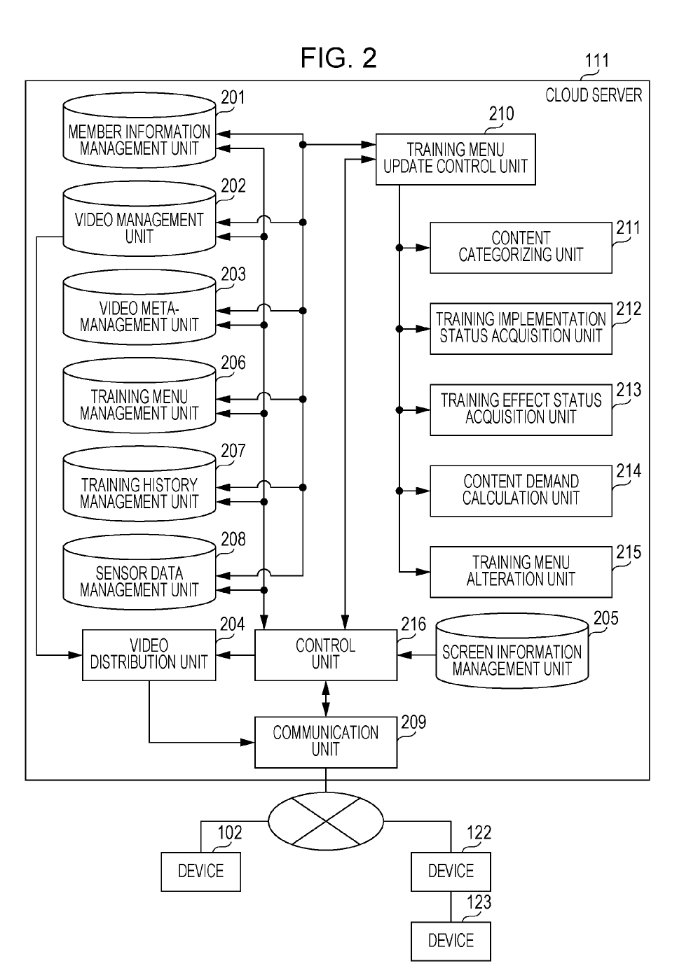

FIG. 2 is a block diagram depicting an example of a configuration of the online training system in the present embodiment. The online training system is provided with the cloud server 111, the device 102, the device 122, and the device 123. It should be noted that the online training system is also simply referred to as a training system.

The cloud server 111 is a server device that manages the member information and content. The cloud server 111 is provided with a member information management unit 201, a video management unit 202, a video meta-management unit 203, a video distribution unit 204, a screen information management unit 205, a training menu management unit 206, a training history management unit 207, a sensor data management unit 208, a communication unit 209, a training menu update control unit 210, a content categorizing unit 211, a training implementation status acquisition unit 212, a training effect status acquisition unit 213, a content demand calculation unit 214 that analyzes content, a training menu alteration unit 215, and a control unit 216.

The member information management unit 201 is a processing unit that retains and manages the member information of members who have enrolled in the online training service.

The video management unit 202 is a processing unit that retains and manages video content distributed as training menus.

The video meta-management unit 203 is a processing unit that retains and manages metadata of video content.

The video distribution unit 204 is a processing unit that distributes videos to member terminals. The video distribution unit 204 corresponds to a presentation unit.

The screen information management unit 205 is a processing unit that manages screen information for creating an application screen and a website screen, to be displayed on the device 102 used by the trainer 101 and the device 122 used by the trainee 121.

The training menu management unit 206 is a processing unit that retains and manages personal training menus created for each trainee.

The training history management unit 207 is a processing unit that retains and manages records of the trainees having trained according to the personal training menus.

The sensor data management unit 208 is a processing unit that retains and manages vital data notified from the device 123 of a trainee such as sensor data for a daily body weight, body fat percentage, or the like.

The communication unit 209 is a communication processing unit that communicates with the device 102, which is the trainer terminal, and the device 122, which is the member terminal.

The training menu update control unit 210 is a processing unit that controls the flow of a series of training menu alteration processing up to a training menu being altered after content to be additionally produced from information retained by the cloud server 111 has been analyzed and notified to the trainer and the trainer has additionally produced the content.

The content categorizing unit 211 is a processing unit that categorizes content according to training characteristics.

The training implementation status acquisition unit 212 is a processing unit that acquires the training implementation status of training. The training implementation status acquisition unit 212 corresponds to an implemented amount acquisition unit.

The training effect status acquisition unit 213 is a processing unit that acquires the training effect status of training. The training effect status acquisition unit 213 corresponds to an effect amount acquisition unit.

The content demand calculation unit 214 is a processing unit that analyzes content of which there is a shortage from the training implementation status and the training effect status. The content demand calculation unit 214 corresponds to a generation unit and an output unit.

The training menu alteration unit 215 is a processing unit that alters a training menu for training.

The control unit 216 is a processing unit that receives input from the device 102, the device 122, and the device 123, transfers data to the member information management unit 201, the video management unit 202, the video meta-management unit 203, the training menu management unit 206, the training history management unit 207, and the sensor data management unit 208, creates screens corresponding to input and transfers the screens to the device 102, the device 122, and the device 123 via the communication unit 209.

The device 102 is a device that is mainly used by the trainer for inputting a personal training menu for each trainee and referring to training implementation statuses.

The device 122 is a device that is mainly used by the trainee for referring to the personal training menu created by the trainer and playing content.

The device 102 and the device 122 may acquire and display an application screen and a website screen created by the control unit 216 of the cloud server 111 or a HyperText Markup Language (HTML) file for generating these screens, and since the device 102 and the device 122 can be realized by a general-purpose device such as a television receiver (TV), a personal computer (PC), a tablet, a smartphone, or a mobile telephone having a communication function and a web browser function, a description thereof is omitted.

The device 123 is a device that is mainly used by the trainee for inputting sensor data such as body weight.

The device 123 has a function to measure the vital data of the trainee and notify the data to the cloud server 111 either directly or via the device 122 using the communication function. Since the device 123 can be realized by a general-purpose device such as a weighing machine, a body composition meter, an activity meter, a blood pressure meter, or a heart rate meter, a description thereof is omitted.

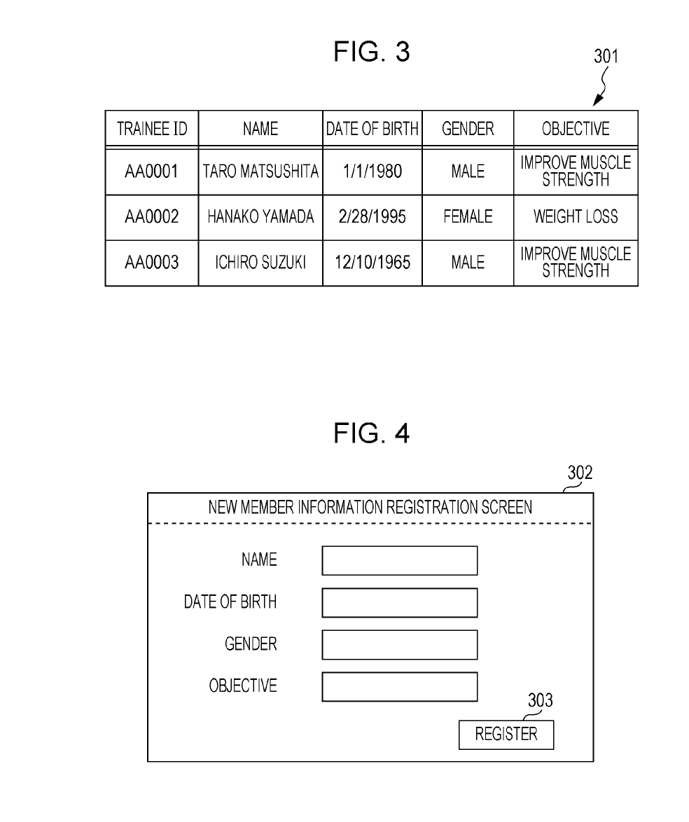

FIG. 3 is an example in which member information retained by the member information management unit 201 is schematically depicted. Member information 301 includes trainee IDs for identifying a plurality of trainees. Furthermore, “name”, “date of birth”, “gender”, and “objective” may be included as the basic information of a trainee. Here, “objective” is the objective for which the trainee enrolled in the online training service. Row 1 of the member information 301 is information relating to one trainee, and information relating to three trainees is managed in the example of FIG. 3.

FIG. 4 is a drawing depicting an example of a new member information registration screen in which the trainee inputs member information.

A new member information registration screen 302 includes input fields for inputting the member information. In the present embodiment, the “name”, “date of birth”, “gender”, and “objective” of the trainee is managed as member information, and therefore input fields for inputting this information are included.

In the present embodiment, the trainee inputs the member information when enrolling in the online training service.

The trainee uses the device 122 to access the cloud server 111 in order to input the member information when enrolling in the online training service. For example, access is made to a website of online training for the trainee managed by the cloud server 111, and access is made to the new member information registration screen 302. When access to the new member information registration screen 302 is detected, the control unit 216 of the cloud server 111 acquires an HTML file necessary for screen creation from the screen information management unit 205, and creates and transmits the new member information registration screen 302 to the device 122 via the communication unit 209. The device 122 uses a web browser or the like to display the new member information registration screen 302.

The trainee uses a keyboard, a software keyboard, a numeric keypad, a mouse, or the like of the device 122 to input the “name”, “date of birth”, “gender”, and “objective” in the new member information registration screen 302 and push a registration button 303. The input name, date of birth, gender, and objective are thereby transmitted from the device 122 to the control unit 216 via the communication unit 209.

The control unit 216 refers to the member information 301 managed by the member information management unit 201, selects and assigns a trainee ID that is not being used, and adds the trainee ID, name, date of birth, gender, and objective of the trainee to the member information management unit 201.

The procedure by which pressing the registration button 303 causes a script for the new member information registration screen 302 to be called and the member information 301 input in the new member information registration screen 302 of the device 122 to be stored in the member information management unit 201, which is a database of the cloud server, is a common technique of a cloud server, and therefore a description thereof is omitted.

The member information is registered according to the aforementioned processing.

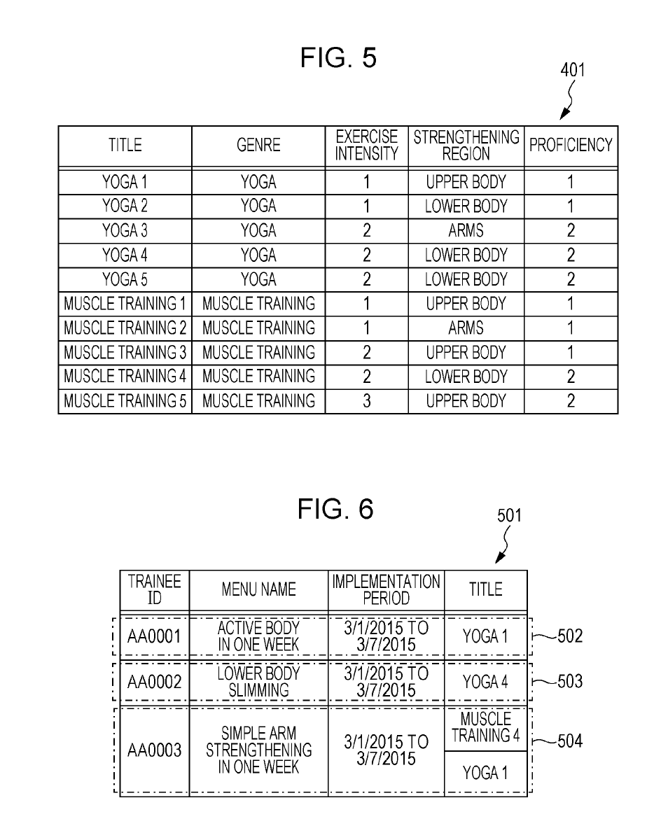

FIG. 5 is an example in which video metadata information retained by the video meta-management unit 203 is schematically depicted. Video metadata information 401 includes the “title” of content. It is possible for content to be identified by the title in the present embodiment; however, it should be noted that a video may be identified by assigning an identifier such as a content ID instead of a title, and that content ID may be managed as video metadata information. Furthermore, the video metadata information 401 includes training characteristics for categorizing content according to the training characteristics.

In the present embodiment, a “genre” indicating the category of an exercise, a “strengthening region” indicating which portion of the body is to be trained, a “proficiency” indicating the degree of proficiency desired for the trainee to use the content as training, and an “exercise intensity” indicating the physical strength or muscular strength desired for the trainee when using the content as training are included as training characteristics; however, the training characteristics are not limited thereto.

It should be noted that information indicating, for example, an item or type of training such as the strengthening region may also be referred to as a “category”. In short, it can also be said that the type of training is linked or associated with the training.

It should be noted that information indicating, for example, the degree of difficulty or order of training such as the exercise intensity may also be referred to as a “level”. In short, it can also be said that the level of training is linked or associated with the training. A level includes the concept of higher and lower levels. For example, training having a higher degree of difficulty is of a higher level than training having a lower degree of difficulty. Furthermore, training having a later order is of a higher level than training having an earlier order.

It should be noted that row 1 of the video metadata information 401 is metadata information of one item of content, and content meta-information exists for the number of items of content that are able to be distributed.

Although not depicted in FIG. 5, it should be noted that “playing time” indicating the playing time of a video may also be included in the video metadata information as a characteristic of the video.

FIG. 6 is an example in which a personal training menu retained by the training menu management unit 206 is schematically depicted.

Personal training menus 501 include trainee IDs for identifying the trainee for which a personal training menu has been created. Furthermore, a “menu name” for identifying and displaying a personal training menu to the trainee may be included. Furthermore, an “implementation period” may be included in a case where an implementation period for personal training is to be designated for the trainee. Furthermore, a “title” of the content that makes up a personal training menu may be included.

For example, a personal training menu 502 is a personal training menu for a trainee having a trainee ID “AA0001”, a personal training menu 503 is a personal training menu for a trainee having a trainee ID “AA0002”, and a personal training menu 504 is a personal training menu for a trainee having a trainee ID “AA0003”.

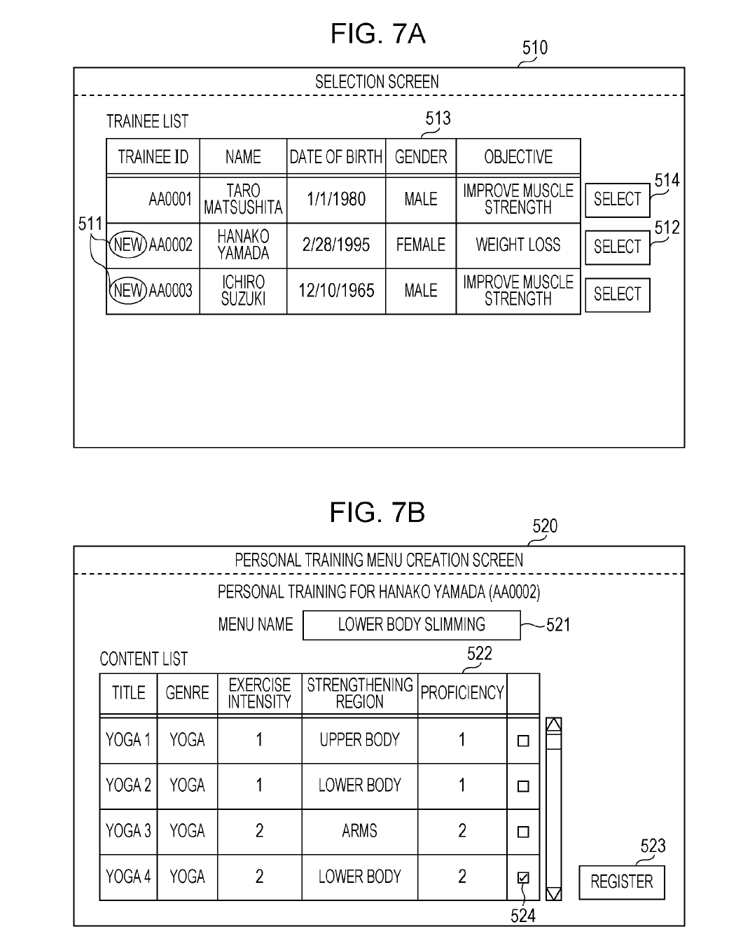

FIGS. 7A and 7B are drawings depicting examples of screens in which a trainer inputs personal training.

In the present embodiment, every other fixed period, every other week for example, the trainer newly creates personal training menus for trainees who have enrolled in the online training service and registered member information during that period. There are cases where a plurality of trainees enrolls in the online training service and registers member information in a fixed period, and therefore one trainee is selected from the plurality of trainees and a personal training menu is then created for the selected trainee.

In order to create personal training, the trainer uses the device 102 to access the cloud server 111. For example, the trainer accesses a trainee selection screen 510 of a trainer-specific online training website managed by the cloud server 111.

When access to the trainee selection screen 510 is detected, the control unit 216 of the cloud server 111 acquires an HTML file necessary for screen creation from the screen information management unit 205, and also acquires member information to be displayed on the screen from the member information 301 of the member information management unit 201. In addition, in order to specify a trainee for whom a personal training menu has not been created, the control unit 216 generates the trainee selection screen 510 by referring to personal training menus managed by the training menu management unit 206. The control unit 216 transmits the generated trainee selection screen to the device 102 via the communication unit 209, and the device 102 uses a web browser or the like to display the trainee selection screen 510.

The procedure by which a script is called at the initial activation of the HTML file for generating the trainee selection screen as described above, member information is acquired from the member information 301 of the member information management unit 201, reference is made to personal training menus managed by the training menu management unit 206 to specify a trainee for whom a personal training menu has not been created, trainees for whom a personal training menu has been created and the trainee for whom a personal training menu has not been created are differentiated and displayed is a common technique of a web service, and therefore a detailed description thereof is omitted.

FIG. 7A is a drawing depicting an example of a trainee selection screen.

A trainee list 513, a new member symbol 511 indicating whether or not a trainee is a new member, and selection buttons 512 and 514 for selecting a trainee are displayed in the trainee selection screen 510.

The trainee ID, name, date of birth, gender, and objective, which are information to which the trainer refers in order to create a personal training menu, are displayed in the trainee list 513 as member information acquired from the member information 301 of the member information management unit 201. Furthermore, reference is made to the personal training menus managed by the training menu management unit 206, and the new member symbol 511 is displayed at the left side of the trainee ID of trainees for whom a personal training menu has not been created. A new member is a trainee for whom a personal training menu has not been created and for whom personal training is to be newly created, and therefore the new member symbol 511 is added in order for the trainer to be able to determine new members.

By pressing the selection button 512, the trainer transitions to a personal training menu creation screen for a trainee to whom the new member symbol 511 has been added.

When access to a personal training menu creation screen 520 is detected, the control unit 216 of the cloud server 111 acquires an HTML file necessary for screen creation from the screen information management unit 205, additionally acquires video metadata information 401 to be displayed on the screen from the video meta-management unit 203, and thereby generates the personal training menu creation screen 520. The control unit 216 transmits the generated personal training menu creation screen 520 to the device 102 via the communication unit 209, and the device 102 uses a web browser or the like to display the personal training menu creation screen 520.

The procedure by which a script is called due to the selection button 512 of the trainee selection screen 510 being pressed, the HTML file for the personal training menu creation screen 520 is called, a script is called at the initial activation of the HTML file, and video metadata information is acquired and displayed is a common technique of a web service, and therefore a detailed description thereof is omitted.

FIG. 7B is a drawing depicting an example of the personal training menu creation screen.

The personal training menu creation screen 520 displays a menu name input field 521 for the trainer to input a training menu, a content list 522 for presenting the video metadata information 401 acquired from the video meta-management unit 203 to the trainer, and a registration button 523 for registering a training menu in the training menu management unit 206 after personal training has been created. It should be noted that content may be displayed by a scroll operation in a case where the content does not fit within one screen.

Furthermore, one content checkbox for selecting content as a personal training menu is displayed for each item of content in the content list 522.

The trainer uses a keyboard or software keyboard of the device 102 to input a training menu name into the menu name input field 521. One or more items of training content are then selected by mouse click operations or touch operations on the screen.

When the trainer selects the content, a check mark 524 for presenting the selected content to the trainer is displayed. When the trainer presses the registration button 523 after the content has been selected, the control unit 216 assigns a value of “Mar. 1, 2015 to Mar. 7, 2015”, which is one week from the present day, as an implementation period for a personal training menu for the trainee having the trainee ID “AA0002”. Furthermore, the control unit 216 registers, in the training menu management unit 206, the personal training menu in which the menu name is “Lower Body Slimming” and the title of the training content is “Yoga 4”, next to which the check mark 524 is displayed. The personal training menu 503 is registered due to this processing.

In the present embodiment, since the implementation period of the personal training menu is one week, “Mar. 1, 2015 to Mar. 7, 2015”, which is one week from the present day, is assigned for the implementation period; however, the implementation period is not limited thereto and may be three days or one month, for example. Furthermore, the trainer may input the implementation period.

In the present embodiment, when the trainer creates a personal training menu at the time of a new enrollment, the cloud server 111 updates the personal training menu thereafter on a regular or non-regular basis. Details of the update procedure for the personal training menu are described later on.

It should be noted that the personal training menu may be updated by the trainer on a regular or non-regular basis at a time other than at the time of a new enrollment. In such a case, the selection button 514 is pressed for a trainee for whom the new member symbol 511 is not displayed, such as the trainee having the trainee ID “AA0001” in the trainee list 513, and the screen transitions to the personal training menu creation screen for the trainee having the trainee ID “AA0001”. In a case other than at the time of a new enrollment, a personal training menu already exists, and therefore the control unit 216 may acquire the personal training menu 502 of the trainee having the trainee ID “AA0001” from the training menu management unit 206, and may display the personal training menu creation screen with the “menu name” serving as an initial value for the training name and the selected “title” content serving as an initial value for the content list. It should be noted that, in a case other than at the time of a new enrollment, training history and sensor data of the trainee already exists, and therefore the training history or the sensor data of the trainee and an analysis result thereof may be displayed on the personal training screen such that the trainer is able to create a personal training menu while referring to the training history or the sensor data.

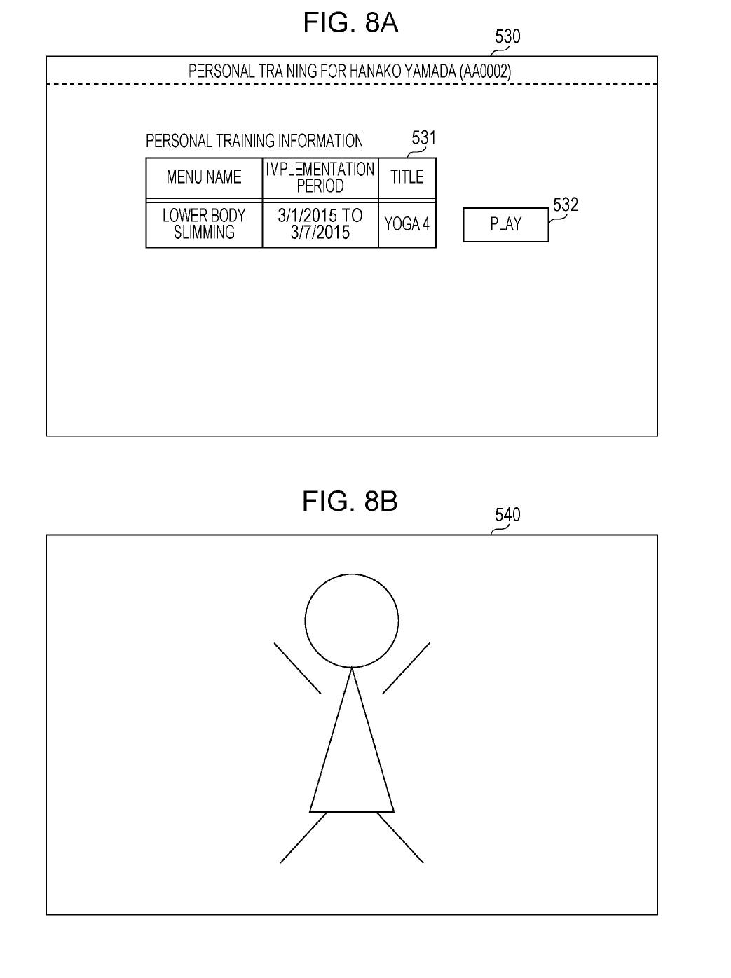

FIGS. 8A and 8B are drawings depicting examples of screens with which the trainee implements personal training.

After the trainer has created personal training, the trainee uses the device 122 to implement the personal training menu. The device 122 is a device that is able to connect to the Internet, such as a smartphone, a tablet, a PC, or a television.

In order to view the content designated by the personal training menu, the trainee uses the device 122 to access the cloud server 111. For example, the trainee accesses a personal training menu screen 530 of a website of online training for the trainee managed by the cloud server 111.

When access to the personal training menu screen 530 is detected, the control unit 216 of the cloud server 111 acquires an HTML file necessary for screen creation from the screen information management unit 205, and also acquires member information to be displayed on the screen from the member information 301 of the member information management unit 201. In addition, the control unit 216 acquires a personal training menu corresponding to the trainee who has accessed the cloud server 111, from the personal training menus 501 of the training menu management unit 206. A trainee is specified by having the trainee ID input at login, for example.

For example, if access has been made from the trainee having the trainee ID “AA0002”, the personal training menu 503 for which the trainee ID is “AA0002” is acquired from the personal training menus 501.

The personal training menu screen 530 is thereby generated. The control unit 216 transmits the generated personal training menu screen 530 to the device 122 via the communication unit 209, and the device 122 uses a web browser or the like to display the personal training menu screen 530.

The procedure by which a script is called at the initial activation of an HTML file for generating the personal training menu screen 530, the trainee ID with which access has been made is specified, and the personal training menu corresponding to the trainee ID is acquired from the training menu management unit 206 and displayed is a common technique of a web service, and therefore a detailed description thereof is omitted.

FIG. 8A is a drawing depicting an example of a personal training menu screen.

Personal training information 531 for describing the details of the personal training menu to the trainee, and a play button 532 that instructs the content included in the personal training to be played are displayed in the personal training menu screen 530.

In a case where the personal training menu is made up of a plurality of items of content, play buttons may be displayed for the number of items of content. Furthermore, a play button for consecutively playing the plurality of items of content may be displayed.

A menu name, an implementation period, and a title are displayed in the personal training information 531 as information acquired from the personal training menu 503.

When the trainee presses the play button 532, the control unit 216 instructs the video distribution unit 204 to distribute the corresponding content. The video distribution unit 204 acquires the corresponding content from the video management unit 202 and distributes the content to the device 122 via the communication unit 209. The device 122 plays the distributed content by way of a web browser function or a player function provided in the device 122. The procedure by which video content is distributed from the cloud server 111, received, and played by way of a web browser function or a player function of the device 122 is a common technique of a web service, and therefore a description thereof is omitted.

FIG. 8B is a drawing depicting an example of a content playback screen. In a content playback screen 540, a video of content corresponding to the play button 532 is played on the entire screen. The trainee performs the same movement using the content being played as an example, and can thereby implement training even though the trainer is not nearby. Trick play such as stopping playback or fast forwarding can be performed by remote control in the case of a TV, and can also be performed by way of a slide bar (not depicted) or the like on the screen with a smartphone or a PC. When the trainee instructs playback to be stopped, the control unit 216 instructs the video distribution unit 204 to stop playback, thereby stopping playback.

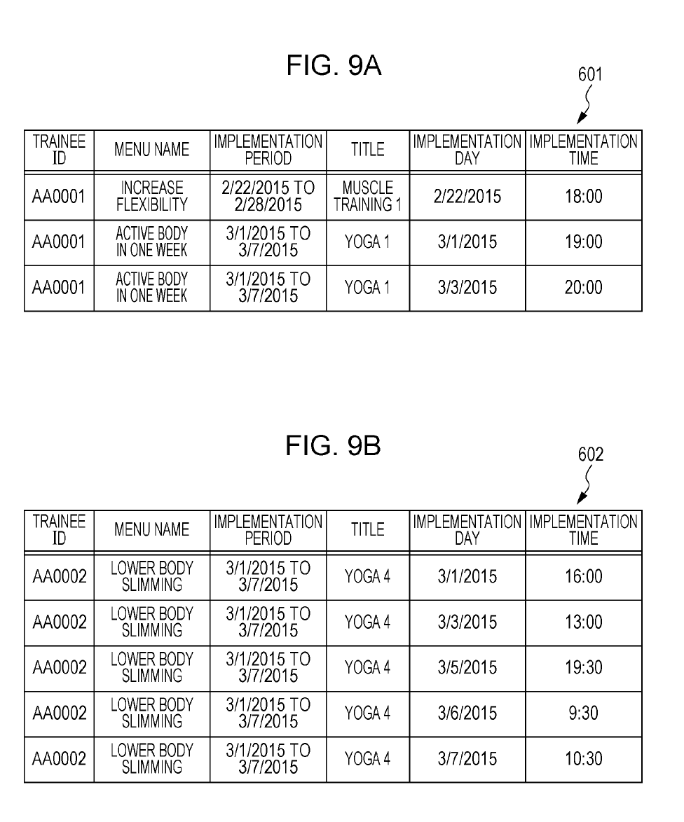

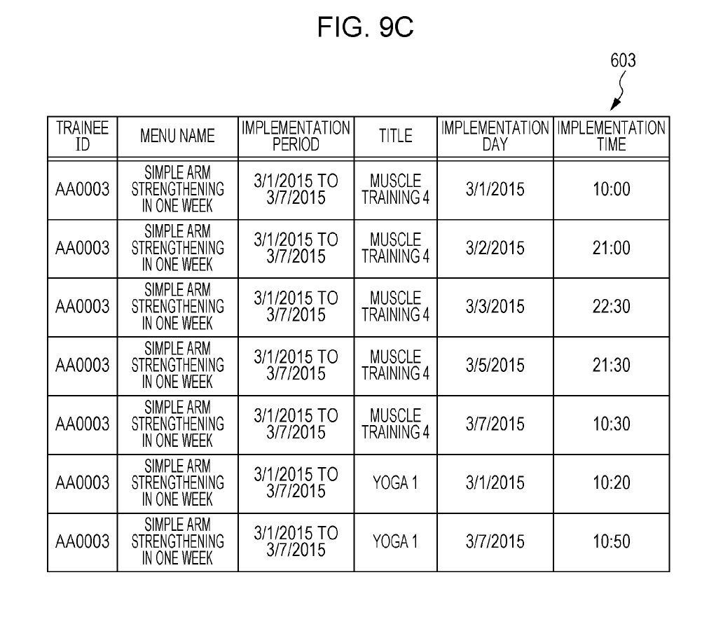

FIGS. 9A, 9B, and 9C are examples in which training histories retained by the training history management unit 207 are schematically depicted. Training history 601, training history 602, and training history 603 include a “trainee ID” in order to identify the trainee who implemented the training, and a content “title” indicating which content has been implemented from among the content designated by the personal training menu. Furthermore, a “menu name” for identifying the personal training menu may be included. Furthermore, an “implementation period” may be included in a case where an implementation period for personal training is to be designated for the trainee. Furthermore, an “implementation day” or an “implementation time” at which training was implemented may be included.

The training history 601 of FIG. 9A is the training history of the trainee having the trainee ID “AA0001”, the training history 602 of FIG. 9B is the training history of the trainee having the trainee ID “AA0002”, and the training history 603 of FIG. 9C is the training history of the trainee having the trainee ID “AA0003”.

The training implementation history is managed by, when the trainee presses the play button 532 in the personal training menu screen 530, for example, and the control unit 216 instructs the video distribution unit 204 to perform distribution, the “trainee ID” of the trainee who pressed the play button 532, the “title” of the content corresponding to the play button, and the “menu name” and “implementation period” of the training being acquired, the “implementation day” and “implementation time” also being acquired from the time at which the play button 532 was pressed, and the acquired items being registered as training history in the training history management unit 207.

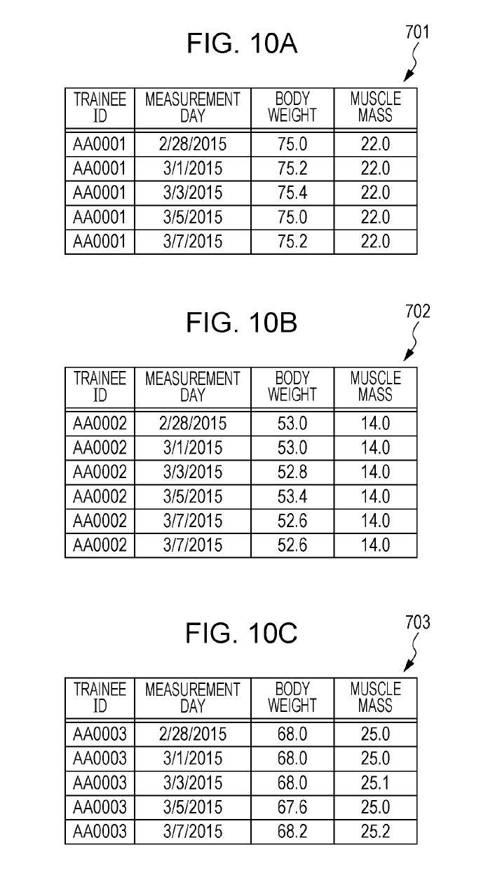

FIGS. 10A, 10B, and 100 are examples in which sensor data retained by the sensor data management unit 208 is schematically depicted. Sensor data 701, sensor data 702, and sensor data 703 include a “trainee ID” in order to identify the trainee to whom the sensor data belongs, and a “measurement day” indicating when the sensor data was measured. In the present embodiment, the sensor data includes “body weight” and “muscle mass”.

The sensor data 701 of FIG. 10A is the sensor data of the trainee having the trainee ID “AA0001”, the sensor data 702 of FIG. 10B is the sensor data of the trainee having the trainee ID “AA0002”, and the sensor data 703 of FIG. 100 is the sensor data of the trainee having the trainee ID “AA0003”.

The sensor data is measured by the device 123 of the trainee 121 and registered in the cloud server 111. For example, the sensor data management unit 208 acquires the device ID of the device 123 in advance, and associates the acquired device ID with the trainee ID. The device 123 notifies values to the cloud server 111 whenever a measurement is performed, and the control unit 216 acquires a trainee ID from the ID of the device from which the notification was received, acquires the notified values such as the bodyweight and muscle mass, acquires the “measurement day” from the time and date at which the notification was received, and registers the acquired items as sensor data in the sensor data management unit 208. Furthermore, the device 122 manages the trainee ID thereof, the device 123 notifies measured sensor data to the device 122 of the same trainee, and the device 122 notifies measurement values together with the trainee ID to the cloud server 111. The control unit 216 acquires the trainee ID and the measurement values such as the body weight and muscle mass, acquires the “measurement day” from the time and date at which the notification was received, and registers the acquired items as sensor data in the sensor data management unit 208.

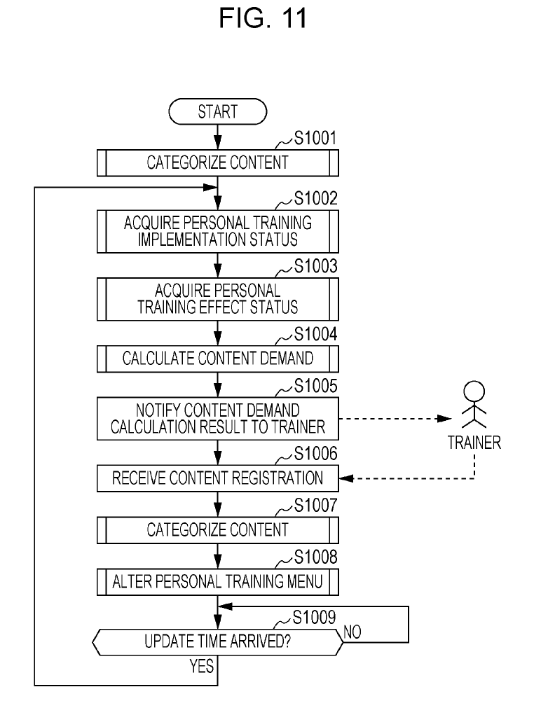

FIG. 11 is a flowchart depicting an example of a procedure by which the cloud server 111 performs a personal training menu update.

In the present embodiment, when the trainer creates a personal training menu at the time of a new enrollment of a trainee, the cloud server 111 updates the personal training menu thereafter on a regular or non-regular basis. For example, the training menu update control unit 210 may execute a personal training menu update procedure on a regular or non-regular basis. Furthermore, the personal training menu update procedure may be executed by the trainer issuing a personal training menu update instruction.

To begin, the training menu update control unit 210 instructs the content categorizing unit 211 to categorize content. The content categorizing unit 211 categorizes content (step S1001). A detailed procedure for categorizing content is described later on.

Next, the training menu update control unit 210 instructs the training implementation status acquisition unit 212 to acquire the personal training implementation status. The training implementation status acquisition unit 212 acquires the personal training implementation status (step S1002). A detailed procedure for acquiring the personal training implementation status is described later on.

Next, the training menu update control unit 210 instructs the training effect status acquisition unit 213 to acquire the personal training effect status. The training effect status acquisition unit 213 acquires the personal training effect status (step S1003). A detailed procedure for acquiring the personal training effect status is described later on.

Next, the training menu update control unit 210 instructs the content demand calculation unit 214 to calculate content demand. The content demand calculation unit 214 calculates content demand (step S1004). A detailed procedure for calculating content demand is described later on. It should be noted that the content demand calculation result indicates content to be additionally produced by the trainer, and may also be referred to as instruction information. In short, instruction information is information indicating content to be newly provided by the trainer.

Next, the training menu update control unit 210 notifies the result of the content demand calculation to the control unit 216. The control unit 216 notifies the content demand calculation result to the device 102 via the communication unit 209, and thereby notifies the content demand calculation result to the trainer (step S1005).

The trainer 101 refers to the content demand calculation result notified in step S1005 and determines whether or not content should be additionally produced, and additionally produces content and registers the content in a case where it is determined that content should be additionally produced.

It should be noted that in a case where it is determined that the additional production of content is not necessary as a result of referring to the content demand calculation result, or in a case where the additional production of content is necessary but the trainer does not have the time to do so, content is not additionally produced. In such a case, the subsequent step S1006 and step S1007 are skipped and processing advances to step S1008.

Next, the video management unit 202 receives registration of content additionally produced by the trainer (step S1006). The trainer registers the additionally produced content and video metadata information of the content in the cloud server 111 via the device 122. In the present embodiment, video metadata information is constituted by a title, genre, exercise intensity, strengthening region, and proficiency managed by the video metadata information 401. When the additionally produced content and the video metadata information are received via the communication unit 209, the control unit 216 of the cloud server 111 notifies the additionally produced content to the video management unit 202 and the video metadata information to the video meta-management unit 203. At such time, for example, the filename of the content or the name of the folder in which the content is arranged may be the same as the “title”, and the folder in which the content is arranged may be managed as the video metadata information such that the association between the content and the video metadata information is clear. It should be noted that the content additionally produced by the trainer may also be referred to as new content.

When the reception of content registration has been completed, the control unit 216 notifies the training menu update control unit 210 that the reception of content registration has been completed, and the training menu update control unit 210 instructs the content categorizing unit 211 to categorize the content. The content categorizing unit 211 once again categorizes the content including the content additionally registered in step S1006 (step S1007).

Next, the training menu update control unit 210 instructs the training menu alteration unit 215 to alter the personal training menu. The training menu alteration unit 215 alters the personal training menu and terminates (step S1008). A detailed procedure for altering the personal training menu is described later on.

Next, the training menu update control unit 210 waits until the next update period for the training menu arrives (step S1009). The update period is a period in which the training menu is reviewed according to the implementation status of the training implemented by the trainee. Specifically, the training menu update control unit 210 waits at the step in question until the update period arrives (“no” in step S1009) and, when the update period arrives (“yes” in step S1009), returns to step S1002 and once again executes the processing of the aforementioned steps.

It should be noted that as long as the categorizing of content (step S1001), the acquisition of the personal training implementation status (step S1002), and the acquisition of the personal training effect status (step S1003) have been completed by when the content demand is calculated (step S1004), the categorizing of content, the acquisition of the personal training implementation status, and the acquisition of the personal training effect status do not have to be performed in the aforementioned order.

The online training system presents content to be added to the trainer in accordance with the series of processing depicted in FIG. 11. In this online training system, personal training menus having an implementation period of one week are created, and the personal training menus are reviewed each week from the training implementation status and training effect status of each trainee, and personal menus for the following week are created or updated. In this online training service, the trainer creates a personal training menu having an implementation period of one week at the time of a new enrollment of a trainee, and updates the personal training menu according to the flowchart depicted in FIG. 11 on the last day (corresponding to the aforementioned “update period”) of the period of each week constituting the implementation period, and thus the trainer additionally produces only optimal content at an optimal timing, and the additionally produced content can be used for altering the personal training menu.

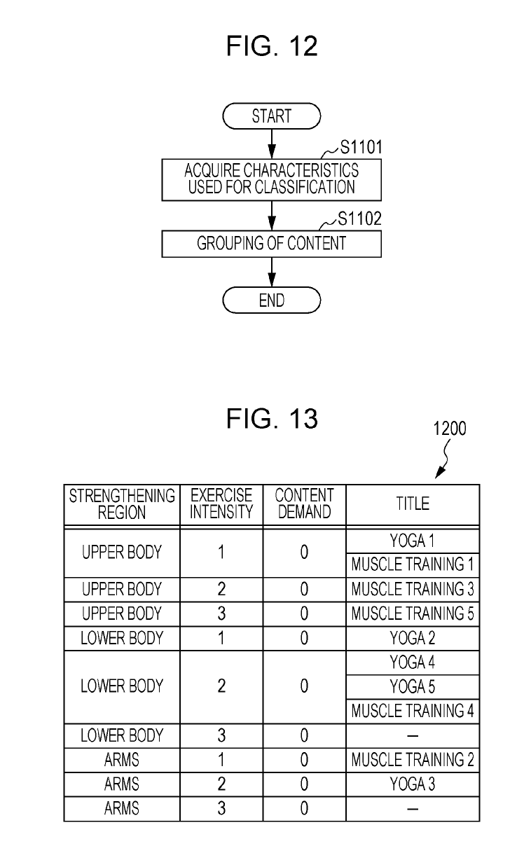

FIG. 12 is a flowchart depicting an example of a procedure for categorizing content.

To begin, the content categorizing unit 211 acquires one or more training characteristics to be used for classification (step S1101). The training characteristics are acquired by selecting from training characteristics retained as video metadata information. In the present embodiment, the genre, exercise intensity, strengthening region, and proficiency are used as training characteristics, and therefore one or more are chosen from thereamong. It should be noted that the training characteristics may be acquired by reading training characteristics retained in advance.

Next, the content categorizing unit 211 refers to the video metadata information 401 of the video meta-management unit 203, and groups the content by grouping content for which values of the training characteristics acquired in step S1101 are all equal (step S1102). For example, in a case where the training characteristics are the strengthening region and exercise intensity, content having equal values for the strengthening region and exercise intensity are placed in the same group.

It should be noted that the training characteristics are not limited to the aforementioned characteristics. The trainer can group content by classification items with which he or she wishes categorization to be performed, by adding the classification items with which he or she wishes categorization to be performed to the video metadata information as training characteristics and assigning values to the added training characteristics.

It should be noted that the timing at which the characteristics to be used for classification are acquired is not limited. Furthermore, the characteristics to be used for classification do not have to be decided each time content is grouped. For example, the characteristics to be used for classification may be decided in advance, and when content is categorized, the same characteristics may be used each time to group the content.

FIG. 13 is a drawing of an example in which a content categorizing table is schematically depicted. A content categorizing table 1200 is a table generated as a result of the strengthening region and exercise intensity of the training characteristics being acquired as characteristics to be used for classification for the video metadata information 401 of FIG. 5, and the content being grouped.

The content categorizing table 1200 includes content characteristics indicating which training characteristics have been used for grouping. The content categorizing table of FIG. 13 includes the “strengthening region” and “exercise intensity” since the content has been grouped according to the “strengthening region” and “exercise intensity”.

The content categorizing table 1200 includes the “title” of the content included in each category. For example, “Yoga 1” and “Muscle Training 1” in which the strengthening region is the “upper body” and the exercise intensity is “1” are included in one group. Similarly, “Muscle Training 3” in which the strengthening region is the “upper body” and the exercise intensity is “2” is included in one group. Since there is no content to be put into the group in which the strengthening location is the “lower body” and the exercise intensity is “3”, “−” is input for the title to indicate that such content does not exist.

The content categorizing table 1200 may also include the “content demand” for inputting the demand of the content included in a category, in other words, the degree to which there is a shortage thereof. The value for the “content demand” is decided as a result of performing the content demand calculation of step S1004, and therefore an initial value of “0” is input immediately after the content categorizing of step S1001 has been implemented. It should be noted that an amount indicating the demand of content may also be referred to as the degree of demand.

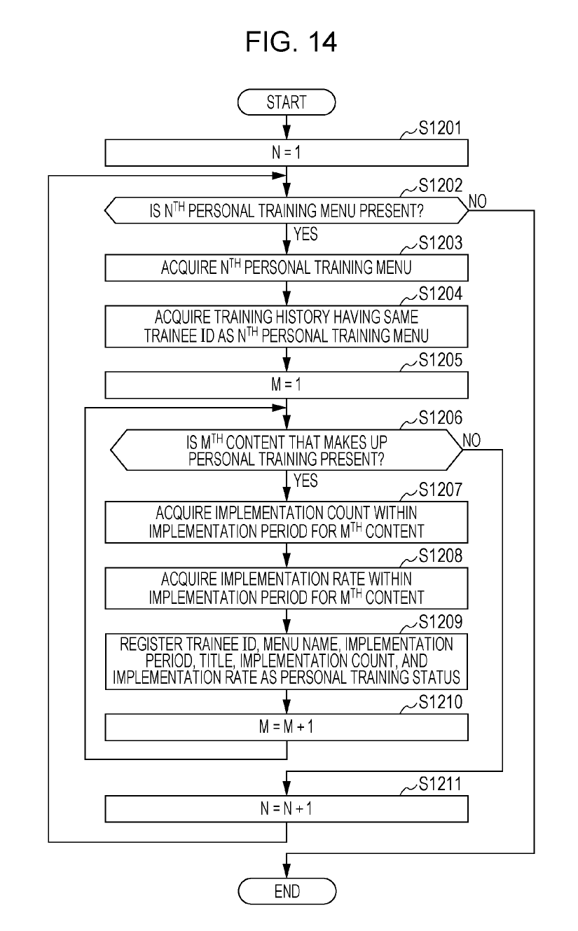

FIG. 14 is a flowchart depicting an example of a personal training implementation status acquisition procedure.

The training implementation status acquisition unit 212 acquires a personal training implementation status in accordance with an instruction from the training menu update control unit 210.

The training implementation status acquisition unit 212 first assigns “1” to the variable N (step S1201). The variable N corresponds to the trainee. Processing for the training menus of all trainees is performed by carrying out processing thereafter while incrementing the variable N.

Next, the training implementation status acquisition unit 212 refers to the personal training menus retained by the training menu management unit 206, and determines whether or not there is an N^{th} personal training menu (step S1202).

Processing advances to step S1203 if the determination result of step S1202 is “yes”, and processing is terminated if the determination result is “no”.

In a case where the determination result of step S1202 was “yes”, the training implementation status acquisition unit 212 acquires information of the N^{th} personal training menu (step S1203).

Next, the training implementation status acquisition unit 212 acquires a training history having the same trainee ID as the N^{th} personal training menu from the training histories retained by the training history management unit 207 (step S1204).

Next, the training implementation status acquisition unit 212 assigns “1” to a variable M (step S1205). The variable M corresponds to content. Processing for all content included in the training menu is performed by carrying out processing thereafter while incrementing the variable M.

Next, the training implementation status acquisition unit 212 refers to the acquired N^{th} personal training menu, and determines whether or not there is M^{th} content that makes up the personal training menu (step S1206). In other words, it is determined whether or not there is M^{th} content in the title column of the N^{th} personal training menu.

Processing advances to step S1207 if the determination result of step S1206 is “yes”, and processing advances to step S1211 if the determination result is “no”.

In a case where the determination result of step S1206 was “yes”, the training implementation status acquisition unit 212 refers to training history having the same trainee ID as the acquired N^{th} personal training menu, and acquires an implementation count within the implementation period for the M^{th} content (step S1207). In other words, the number of times that the “title” of the training history is the same as the M^{th} content and the “implementation day” of the training history is included within the “implementation period” of the personal training is counted and used as the implementation count.

It should be noted that a count of 1 may be made in a case where there are two or more training histories having the same content on the same day.

Next, the training implementation status acquisition unit 212 acquires the implementation rate within the implementation period for the M^{th} content (step S1208). The implementation rate can be calculated with the following numerical formula from the “implementation count” acquired in step S1207 and the number of days within the “implementation period” of the personal training.

Implementation rate [%]=implementation count/number of days of “implementation period”×100

Next, the training implementation status acquisition unit 212 adds the trainee ID, menu name, implementation period, title, implementation count, and implementation rate to a training status table (step S1209).

Next, the training implementation status acquisition unit 212 increments the value of M by 1, and processing returns to step S1206 (step S1210).

In a case where the determination result of step S1206 was “no”, the value of N is incremented by 1, and processing returns to step S1202 (step S1211).

In the present embodiment, the implementation count or implementation rate of content is used as the implementation status of personal training; however, it should be noted that the implementation status is not limited thereto. For example, the training time or the like may be used.

In a case where something other than the implementation count or implementation rate of content is used as the implementation status of personal training, information with which the implementation status can be calculated is acquired as training implementation history, and a step is provided in which the training implementation status is calculated instead of step S1207 and step S1208.

It should be noted that an amount indicating the implementation status of personal training may also be referred to as an implemented amount. In other words, a specific example of the implemented amount is the implementation count, the implementation rate, or the like.

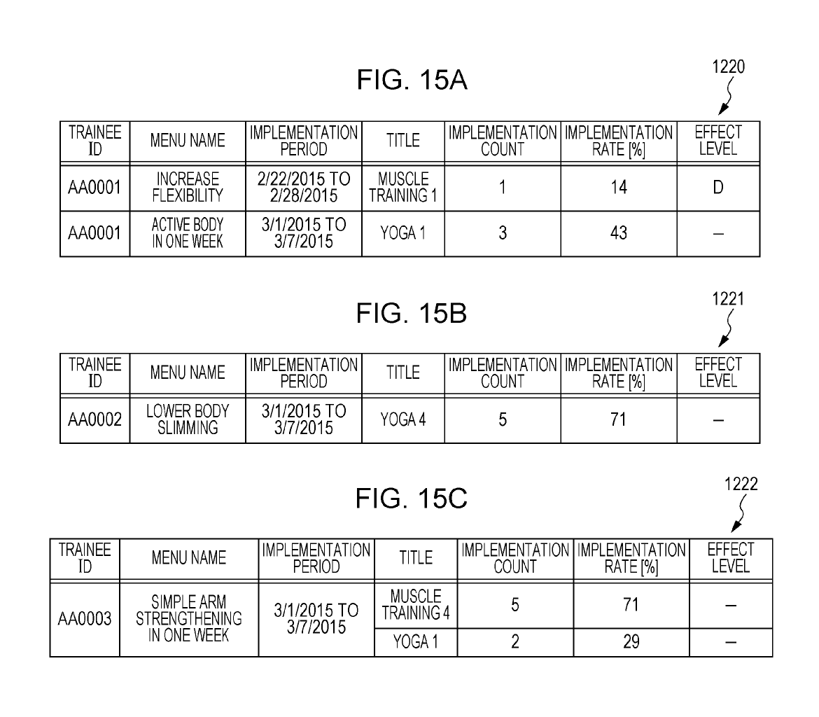

FIGS. 15A, 15B, and 15C are examples in which training status tables are schematically depicted. The training status tables are created by using the personal training menus 501 of FIG. 6, the training history 601 of FIG. 9A, the training history 602 of FIG. 9B, and the training history 603 of FIG. 9C to acquire personal training implementation statuses.

Training implementation status tables 1220, 1221, and 1222 include the “trainee ID” for identifying the trainee who implemented training, and the “title” of the content with which the trainee implemented the training. Furthermore, the “menu name” and the “implementation period” may be included in order to identify the personal training and the implementation period. The training status tables include information relating to the implementation status of training. In the present embodiment, the “implementation count” indicating how many times training has been implemented using the content in question within the implementation period, and the “implementation rate” indicating a percentage at which training using the content in question has been implemented within the implementation period, are included as the implementation status of training.

The information relating to the implementation status of training is not limited thereto. For example, the training time or the like may be included in the implementation status of training.

The training status tables include information relating to the training effect status. In the present embodiment, an “effect level” indicating the degree to which there has been an effect within the implementation period is included.

The information relating to the effect status of training is not limited thereto. For example, the body weight, the body fat percentage, or the amount of increase/decrease or the rate of increase/decrease in muscle mass may be included as the training effect status.

The “effect level” is acquired by acquiring the training effect status, and therefore, for data rows in which the training implementation status has been acquired but the training effect status has yet to be acquired, a value is not entered and “−” is input.

There is a training status table for each trainee ID, and the implementation status and effect status for personal training from when the trainee enrolled are managed therein. The training implementation status table 1220 includes the training implementation status and effect status for the trainee having the trainee ID “AA0001”. Since the trainee having the trainee ID “AA0001” enrolled on Feb. 22, 2015, a training implementation status for two weeks is managed.

The training implementation status tables 1220, 1221, and 1222 are managed in the training implementation status acquisition unit 212.

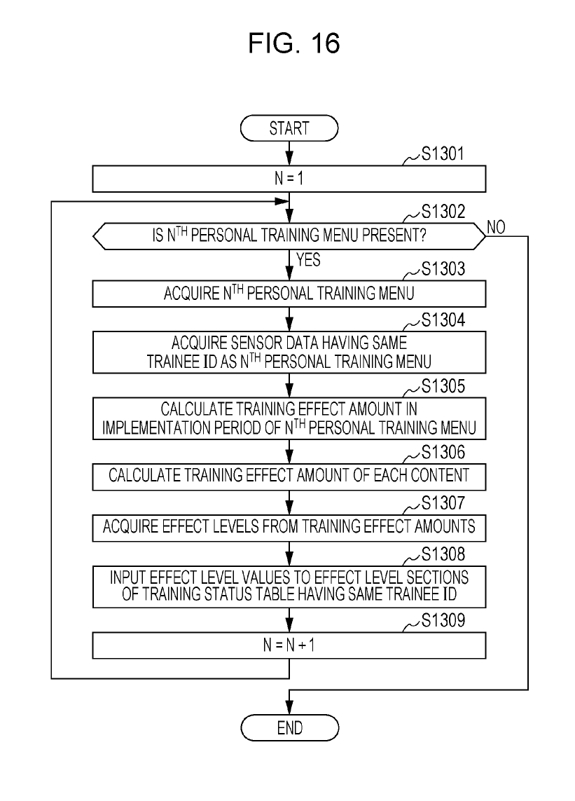

FIG. 16 is a flowchart depicting an example of a personal training effect status acquisition procedure.

The training effect status acquisition unit 213 acquires a personal training effect status in accordance with an instruction from the training menu update control unit 210.

The training effect status acquisition unit 213 first assigns “1” to the variable N (step S1301).

Next, the training effect status acquisition unit 213 refers to the personal training menus retained by the training menu management unit 206, and determines whether or not there is an N^{th} personal training menu (step S1302).

Processing advances to step S1303 if the determination result of step S1302 is “yes”, and processing is terminated if the determination result is “no”.

In a case where the determination result of step S1302 was “yes”, the training effect status acquisition unit 213 acquires information of the N^{th} personal training menu (step S1303).

Next, the training effect status acquisition unit 213 acquires sensor data having the same trainee ID as the N^{th} personal training menu from the sensor data retained by the sensor data management unit 208 (step S1304).

Next, the training effect status acquisition unit 213 calculates the training effect amount in the implementation period of the N^{th} personal training menu (step S1305). In the present embodiment, a description has been given using the amount of increase/decrease in body weight as the training effect amount; however, the information used as the training effect amount is not limited thereto. For example, the amount of increase/decrease in muscle mass, the percentage of increase/decrease in body fat percentage, the amount of increase/decrease in the size of the circumference of a region of the body such as the waist or hips, or the like may be used. It should be noted that the training effect amount is also simply referred to as the effect amount.

In a case where the amount of increase/decrease in body weight is used as the training effect amount, the training effect amount of the personal training is calculated with the following numerical formula.

Training effect amount of personal training=(most recent body weight)−(most recent body weight prior to implementation period of personal training menu)

It should be noted that in a case where there is no body weight data from prior to the implementation period of the personal training menu, the earliest body weight within the implementation period of the personal training menu may be used.

Next, the training effect status acquisition unit 213 calculates the training effect amount of each item of content (step S1306). This processing is performed in order to calculate the training effect amount of each item of content in a case where a personal training menu is made up of a plurality of items of content.

In order to calculate the training effect amount of each item of content, training history having the same trainee ID as the N^{th} personal training menu is acquired.

The training effect amount of specific content is calculated with the following numerical formula, and the following numerical formula is used to calculate the training effect amount for all content making up the personal training menu.

Training effect of specific content=(implementation count of specific content within implementation period)/(implementation count of all content within implementation period)×(effect amount of personal training)

In the aforementioned example, the training effect of content is calculated using an implementation count percentage; however, the method for calculating the effect amount of each item of content is not limited thereto. For example, a training time length percentage, a calorie consumption percentage, or the like may be used.

Next, the training effect status acquisition unit 213 acquires effect levels from the training effect amounts (step S1307). In other words, a conversion is performed from a training effect amount, which is numerical value information, to an effect level that indicates the degree of effect.

Next, with respect to a training status table created in step S1002, the training effect status acquisition unit 213 inputs the effect level values calculated in step S1307 into effect level sections of the training status table having the same trainee ID (step S1308).

Next, the training effect status acquisition unit 213 increments the value of N by 1, and processing returns to step S1302 (step S1309).

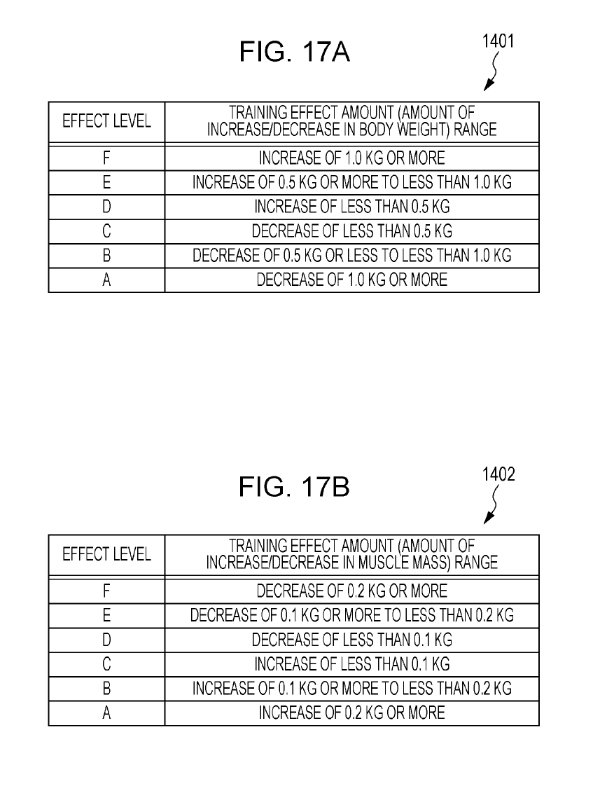

FIG. 17A is a drawing depicting an example of an effect level mapping table for converting an amount of increase/decrease in body weight, which is an example of a training effect amount, into an effect level. An effect level mapping table 1401 includes an “effect level” that is an index indicating the degree of effect of training, and a “training effect amount range” that indicates the range of the training effect amount corresponding to each effect level. Here, a description is given using the amount of increase/decrease in body weight as the training effect amount, and the “training effect amount range” is the range of the amount of increase/decrease in body weight. For example, effect level “A” is assigned to a trainee whose body weight has decreased by 1 kg or more within the implementation period of the personal training menu.

In the present embodiment, a description has been given using the amount of increase/decrease in body weight as the training effect amount; however, in a case where a different index is used for the training effect amount, such as the amount of increase/decrease in muscle mass, the percentage of increase/decrease in body fat percentage, or the amount of increase/decrease in the size of the circumference of a region of the body such as the waist or hips, the range corresponding to the different index is entered into the training effect amount range.

For example, the amount of increase/decrease in muscle mass can also be used as the training effect amount. FIG. 17B is a drawing depicting an example of an effect level mapping table for converting an amount of increase/decrease in muscle mass, which is an example of a training effect amount, into an effect level. For example, the effect level “A” is assigned to a trainee whose muscle mass has increased by 0.2 kg or more within the implementation period of the personal training menu.

It should be noted that, in the present embodiment, the training effect amount is calculated using the same values, namely the amount of increase/decrease in body weight, for all trainees; however, the training effect amount may be calculated using different values for each trainee. For example, the training effect amount may be calculated using the amount of increase/decrease in body weight for trainees having an enrollment objective of “weight loss”, and the training effect amount may be calculated using the amount of increase/decrease in muscle mass for trainees having an enrollment objective of “improve muscle strength”. In such a case, it is necessary for the effect level mapping table to include the “effect level”, the “training effect amount range” for the case where the amount of increase/decrease in body weight is used as the training effect amount, and the “training effect amount range” for the case where the amount of increase/decrease in muscle mass is used as the training effect amount.

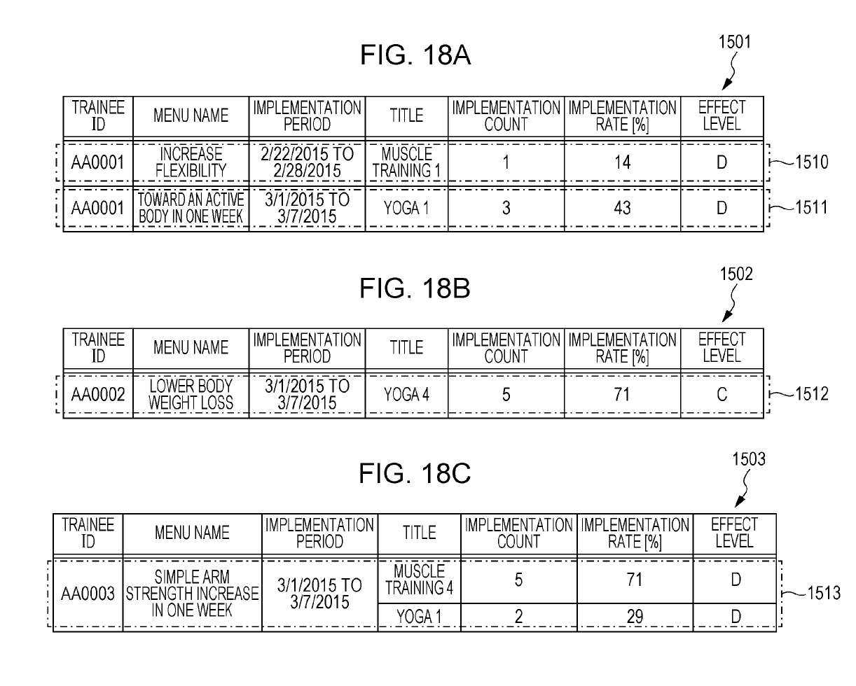

FIGS. 18A, 18B, and 18C are examples schematically depicting training effect status tables having input therein results that are obtained by using the sensor data of FIGS. 10A, 10B, and 100 to acquire personal training effect statuses. The items therein are the same as in FIGS. 15A, 15B, and 15C, and therefore descriptions thereof are omitted.

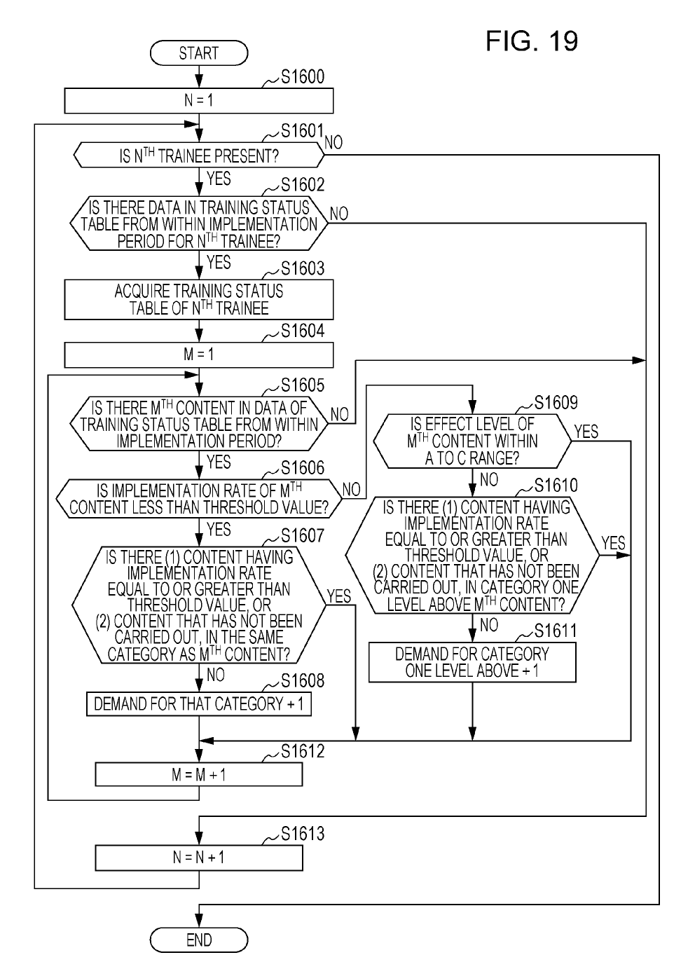

FIG. 19 is an example of a flowchart depicting a detailed procedure for calculating content demand.

The content demand calculation unit 214 calculates content demand in accordance with an instruction from the training menu update control unit 210.

To begin, the content demand calculation unit 214 assigns “1” to the variable N (step S1600).

The content demand calculation unit 214 refers to the member information retained by the member information management unit 201, and determines whether or not there is an N^{th} trainee (step S1601).

Processing advances to step S1602 if the determination result is “yes”, and processing is terminated if the determination result is “no”.

In a case where the determination result of step S1601 was “yes”, the content demand calculation unit 214 refers to the training implementation status table of the N^{th} trainee, and determines whether or not there is a data row in the training implementation status table from within the implementation period (step S1602).

Processing advances to step S1603 if the determination result is “yes”, and processing advances to step S1613 if the determination result is “no”.

In a case where the determination result was “yes” in step S1602, the content demand calculation unit 214 acquires the training status table from within the implementation period of the N^{th} trainee (step S1603).

Next, the content demand calculation unit 214 assigns “1” to the variable M (step S1604).

Next, the content demand calculation unit 214 determines whether or not there is M^{th} content in the data row of the training status table from within the implementation period (step S1605).

Processing advances to step S1606 if the determination result is “yes”, and processing advances to step S1613 if the determination result is “no”.

In a case where the determination result was “yes” in step S1605, the content demand calculation unit 214 refers to the data row of the training status table from within the implementation period, and determines whether or not the implementation rate of the M^{th} content is less than a threshold value (step S1606).

In the present embodiment, a determination is made according to whether or not the implementation rate of content is less than a threshold value in order to determine whether or not the implementation status of the content is equal to or greater than a fixed level; however, it should be noted that the method for determining the implementation status of content is not limited thereto. For example, the implementation count of content or the training time may be used for the determination.

Processing advances to step S1607 if the determination result of step S1606 is “yes”, and processing advances to step S1609 if the determination result is “no”.

In a case where the determination result was “yes” in step S1606, the content demand calculation unit 214 refers to the content categorization result of step S1001 and the data row of the training implementation status table from prior to the implementation period, and determines whether or not there is (1) content having an implementation rate that is equal to or greater than a threshold value, or (2) content that has not been implemented, in the same category as the M^{th} content (step S1607).

Processing advances to step S1612 if the determination result is “yes”, and processing advances to step S1608 if the determination result is “no”.

In a case where the determination result was “no” in step S1607, the content demand calculation unit 214 increments, by 1, the value of “content demand” for a category including the M^{th} content of the content categorizing table, and processing advances to step S1612 (step S1608).

It should be noted that, in step S1608, the content demand calculation unit 214 can use the content categorizing table generated in step S1001 for the first time, and can use the content categorizing table generated in step S1007 for the second time and thereafter.

In a case where the determination result was “no” in step S1606, the content demand calculation unit 214 refers to the data row of the training status table from within the implementation period, and determines whether or not the effect level of the M^{th} content is equal to or greater than a fixed level, specifically, whether or not the effect level is within the range of A to C (step S1609). This determination determines whether or not a prescribed effect is exhibited in the body of the trainee due to training based on the M^{th} content. Furthermore, this determination determines whether or not the effect level obtained by conversion from the training effect amount relating to the body of the trainee satisfies the condition of “the effect level being within the range of A to C”, in which the effect level indicates that a prescribed effect is exhibited in the body of the trainee.

In the present embodiment, it is determined whether or not the effect level is within the range of A to C in order to determine whether or not the effect level is equal to or greater than a fixed level; however, it should be noted that the method for determining the effect status of content is not limited thereto. For example, the effect level may be a value other than “C”. Furthermore, the training effect amount corresponding to content may be used for the determination.

Processing advances to step S1612 if the determination result is “yes”, and processing advances to step S1610 if the determination result is “no”.

In a case where the determination result was “no” in step S1609, the content demand calculation unit 214 refers to the content categorization result of step S1001, refers to the data row of the training implementation status table from prior to the implementation period, and determines whether or not there is (1) content having an implementation rate that is equal to or greater than a threshold value, or (2) content that has not been implemented, in the category one level above the M^{th} content (step S1610).

Here, a category that is one level above refers to a category in which numerical data is higher by 1 with regard to a content characteristic that can be expressed with numerical data such as the exercise intensity or proficiency.

For example, in the content categorizing table of FIG. 13, the category one level above the category in which the strengthening region is the “upper body” and the exercise intensity is “1” refers to the category in which the strengthening region is the “upper body” and the exercise intensity is “2”.

Processing advances to step S1612 if the determination result of step S1610 is “yes”, and processing advances to step S1611 if the determination result is “no”.

In a case where the determination result of step S1610 was “no”, the content demand calculation unit 214 increments the value of “content demand” for the category one level above the category of the M^{th} content in the content categorizing table by 1, and processing advances to step S1612 (step S1611).

In a case where the determination result of step S1607 was “yes”, in a case where the processing of step S1608 was terminated, in a case where the determination result of step S1609 was “yes”, in a case where the determination result of step S1610 was “yes”, and in a case where the processing of step S1611 was terminated, the value of the variable M is incremented by 1, and processing returns to step S1605 (step S1612).

In a case where the determination result of step S1602 was “no”, and in a case where the determination result of step S1605 was “no”, the value of the variable N is incremented by 1, and processing returns to step S1601 (step S1613).

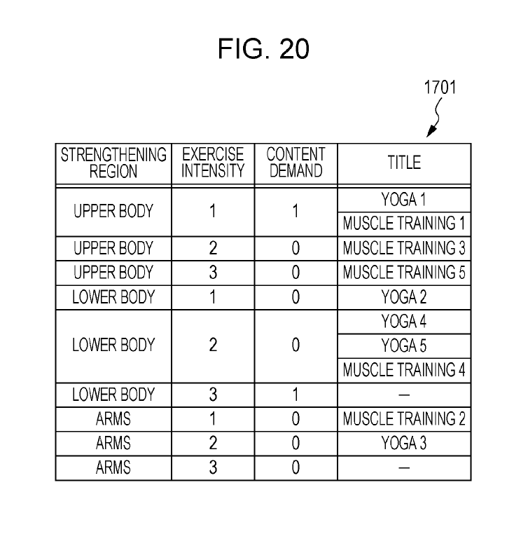

FIG. 20 is a drawing of an example schematically depicting a content categorizing table in which the value of “content demand” is decided according to the content demand calculation of step S1004. The items of the content categorizing table are the same as in FIG. 13, and therefore descriptions thereof are omitted.

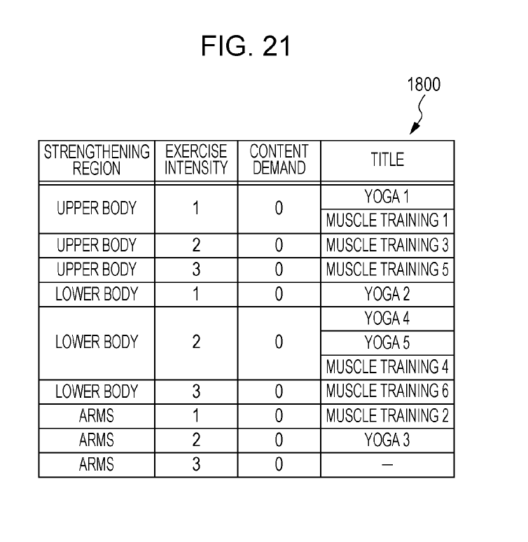

FIG. 21 depicts the results of having once again categorized content after additionally registered content produced by the trainer with reference to the content demand calculated in step S1004 has been added to the content categorizing table. The items of the content categorizing table are the same as in FIG. 13, and therefore descriptions thereof are omitted.

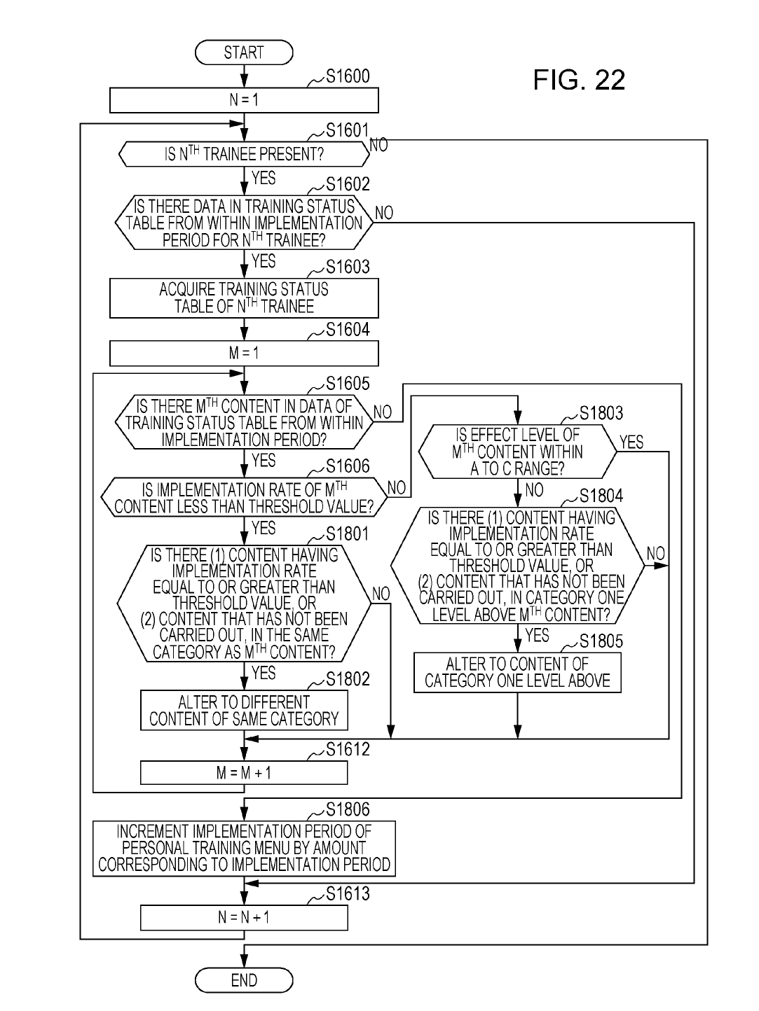

FIG. 22 is a flowchart depicting an example of a detailed procedure for altering a personal training menu.

The training menu alteration unit 215 alters the personal training menu in accordance with an instruction from the training menu update control unit 210.

Step S1600, step S1601, step S1602, step S1603, step S1604, step S1605, step S1606, step S1612, and step S1613 are the same as in the content demand calculation and descriptions thereof are therefore omitted, and a description is given with regard to step S1801, step S1802, step S1803, step S1804, step S1805, and step S1806.

In a case where the determination result of step S1606 was “yes”, the training menu alteration unit 215 refers to the content categorizing table from after content has once again been categorized in step S1007 after content has been registered in step S1006 with respect to the content categorization result of step S1001, and data rows of the training implementation status table from prior to the implementation period, and determines whether or not there is (1) content having an implementation rate that is equal to or greater than a threshold value, or (2) content that has not been implemented, in the same category as the M^{th} content (step S1801).

Processing advances to step S1802 if the determination result is “yes”, and processing advances to step S1612 if the determination result is “no”.

In a case where the determination result was “yes” in step S1801, the training menu alteration unit 215 alters the M^{th} content of the N^{th} personal training menu retained by the training menu management unit 206, to (1) the content having an implementation rate that is equal to or greater than a threshold value, or (2) the content that has not been implemented, in the same category as the M^{th} content, and processing advances to step S1612 (step S1802). It should be noted that the training menu alteration unit 215 is also capable of selecting the aforementioned content and altering the M^{th} content of the N^{th} personal training menu to the selected content.

Furthermore, in a case where the determination result of step S1606 was “no”, the training menu alteration unit 215 refers to a data row of the training status table from within the implementation period, and determines whether or not the effect level of the M^{th} content is within the range of A to C (step S1803).

Processing advances to step S1612 if the determination result was “yes”, and processing advances to step S1804 if the determination result was “no”.

In a case where the determination result of step S1803 was “no”, the training menu alteration unit 215 refers to the content categorizing table from after content has once again been categorized in step S1007 after content has been registered in step S1006 with respect to the content categorization result of step S1001, and the data rows of the training implementation status table from prior to the implementation period, and determines whether or not there is (1) content having an implementation rate that is equal to or greater than a threshold value, or (2) content that has not been implemented, in the category one level above the M^{th} content (step S1804). It should be noted that the training menu alteration unit 215 is also capable of selecting the aforementioned content and altering the M^{th} content of the N^{th} personal training menu to the selected content.

Processing advances to step S1805 if the determination result is “yes”, and processing advances to step S1612 if the determination result is “no”.

In a case where the determination result was “yes” in step S1804, the training menu alteration unit 215 alters the M^{th} content of the N^{th} personal training menu retained by the training menu management unit 206, to (1) content having an implementation rate that is equal to or greater than a threshold value, or (2) content that has not been implemented, in the category one level above the M^{th} content, and processing advances to step S1612 (step S1805).

In a case where the determination result was “no” in step S1801, in a case where the processing of step S1802 was terminated, in a case where the determination result was “yes” in step S1803, in a case where the determination result of step S1804 was “no”, and in a case where the processing of step S1805 was terminated, the training menu alteration unit 215 increments the value of the variable M by 1, and processing returns to step S1605 (step S1612).

Furthermore, in a case where the determination result was “no” in step S1605, the training menu alteration unit 215 increments the implementation period of the personal training menu of the N^{th} trainee by an amount corresponding to the implementation period, and processing advances to step S1613 (step S1806). For example, the implementation period of the personal training menu for the trainee having the trainee ID “AA0001” of FIG. 6 is one week from Mar. 1, 2015 to Mar. 7, 2015, and therefore the value obtained by incrementing by an amount corresponding to the implementation period becomes Mar. 8, 2015 to Mar. 14, 2015.

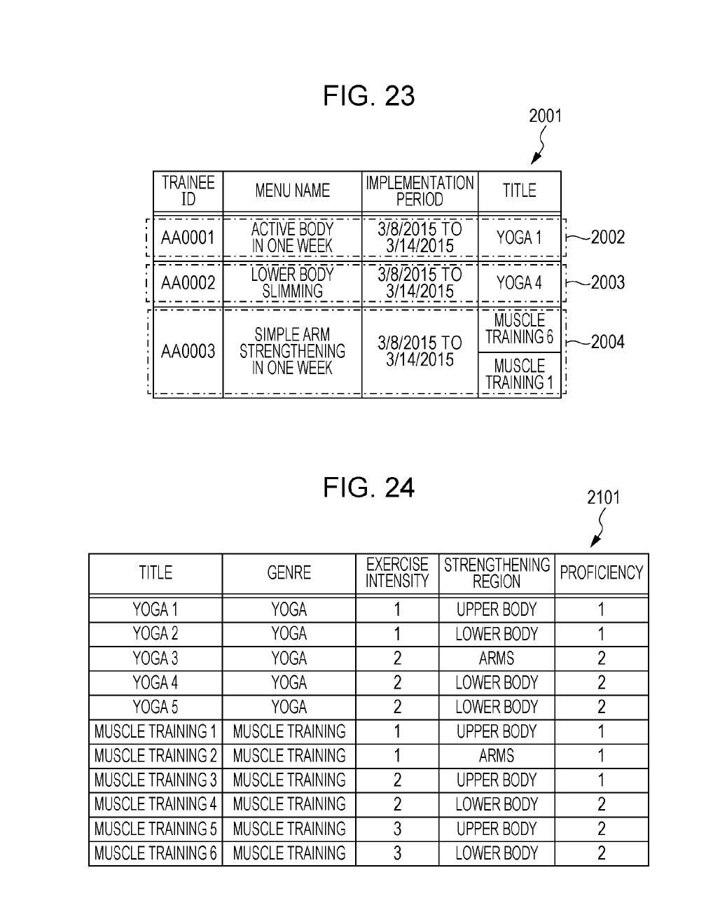

FIG. 23 is personal training obtained as a result of the personal training menus 501 of FIG. 6 having been altered by the personal training menu update of step S1008.

The items of a personal training menu 2001 are the same as in FIG. 6, and therefore descriptions thereof are omitted.

Here, the flow of a personal training update is described using the flowchart of FIG. 11 and actual data.

The member information management unit 201 retains the member information 301, the video meta-management unit 203 retains the video metadata information 401, the training menu management unit 206 retains the personal training menus 501, the training history management unit 207 retains the training history 601, the training history 602, and the training history 603, and the sensor data management unit 208 retains the sensor data 701, the sensor data 702, and the sensor data 703.

To begin, the training menu update control unit 210 instructs the content categorizing unit 211 to categorize content, and the content categorizing unit 211 categorizes content (step S1001).

Here, the flow of the content categorization is described using the flowchart of FIG. 12 and the video metadata information 401 of FIG. 5.

To begin, the “strengthening region” and “exercise intensity” are acquired as training characteristics to be used for classification (step S1101).

Next, the content is grouped by referring to the video metadata information 401 of the video meta-management unit 203 and grouping the content for which values of the “strengthening region” and “exercise intensity”, which are the training characteristics acquired in step S1101, are all equal (step S1102).

According to the aforementioned processing, the content categorizing table 1200 is completed from the video metadata information 401.

Here, we will return to the flowchart of FIG. 11. Next, the training menu update control unit 210 instructs the training implementation status acquisition unit 212 to acquire the personal training implementation status. The training implementation status acquisition unit 212 acquires the personal training implementation status (step S1002).

Here, the flow for acquiring the personal training implementation status will be described using the flowchart of FIG. 14, the personal training menus 501 of FIG. 6, and the training histories of FIG. 9A, FIG. 9B, and FIG. 9C.

The training implementation status acquisition unit 212 first assigns “1” to the variable N (step S1201).

Next, the training implementation status acquisition unit 212 refers to the personal training menus 501 retained by the training menu management unit 206, and determines whether or not there is a first personal training menu (step S1202).

Since the determination result of step S1202 is “yes”, the training implementation status acquisition unit 212 acquires the personal training menu 502, which is information of the first personal training menu (step S1203).

Next, the training implementation status acquisition unit 212 acquires the training history 601, which is training history having the same trainee ID “AA0001” as the first personal training menu, from the training histories retained by the training history management unit 207 (step S1204).

Next, the training implementation status acquisition unit 212 assigns “1” to the variable M (step S1205).

Next, the training implementation status acquisition unit 212 refers to the personal training menu 502, which is the acquired first personal training menu, and determines whether or not there is first content that makes up the personal training menu (step S1206).

Since content having the title “Yoga 1” exists as first content of the personal training menu 502, the determination result is “yes”.

Since the determination result of step S1206 is “yes”, the training implementation status acquisition unit 212 refers to the training history 601, which is training history having the same trainee ID “AA0001” as the personal training menu 502 that is the acquired first personal training menu, and acquires the implementation count within the implementation period for “Yoga 1” that is the first content (step S1207). When reference is made to the training history 601, “Yoga 1” has been implemented on Mar. 1, 2015 and Mar. 3, 2015 between Mar. 1, 2015 and Mar. 7, 2015, which is within the implementation period, and therefore “2” is acquired as the implementation count.

Next, the training implementation status acquisition unit 212 acquires the implementation rate within the implementation period for the first content (step S1208). The implementation rate can be calculated with the following numerical formula from the “implementation count” acquired in step S1207 and the number of days of the “implementation period” of the personal training.

Implementation rate [%]=implementation count/number of days of “implementation period”×100

Since the implementation count is “2” and the number of days of the implementation period is “7”, “43(%)” is acquired as the implementation rate.

Next, a trainee ID of “AA0001”, a menu name of “Active Body in One Week”, an implementation period of “Mar. 1, 2015 to Mar. 7, 2015”, a title of “Yoga 1”, an implementation count of “2”, and an implementation rate of “43” are added to the training status table by the training implementation status acquisition unit 212 to produce the training implementation status table 1220 (step S1209).

Next, the training implementation status acquisition unit 212 increments the value of M by 1, and processing returns to step S1206 (step S1210).

Next, the training implementation status acquisition unit 212 determines whether or not there is second content that makes up the personal training, and since the determination result is “no”, processing advances to step S1211, the value of N is incremented by 1, and processing returns to step S1202 (step S1211).

Similarly, the training implementation status table 1221 is generated from the personal training menu 503 of FIG. 6 and the training history 602, the training implementation status table 1222 is generated from the personal training menu 504 of FIG. 6 and the training history 603, and training for all trainees is generated or updated and processing is terminated.

Here, we will return to the flowchart of FIG. 11. Next, the training menu update control unit 210 instructs the training effect status acquisition unit 213 to acquire the personal training effect status. The training effect status acquisition unit 213 acquires the personal training effect status (step S1003).

Here, the flow for acquiring the personal training effect status will be described using the flowchart of FIG. 16, the personal training menus 501 of FIG. 6, the training histories of FIG. 9A, FIG. 9B, and FIG. 9C, the sensor data of FIG. 10A, FIG. 10B, and FIG. 100, the training implementation status tables of FIG. 15A, FIG. 15B, and FIG. 15C, and the effect level mapping table of FIG. 17.

The training effect status acquisition unit 213 first assigns “1” to the variable N (step S1301).

Next, the training effect status acquisition unit 213 refers to the personal training menus 501 retained by the training menu management unit 206, and determines whether or not there is a first personal training menu (step S1302).

Since the determination result of step S1302 is “yes”, the training effect status acquisition unit 213 acquires the personal training menu 502, which is the first personal training menu (step S1303).

Next, the training effect status acquisition unit 213 acquires the sensor data 701, which is sensor data having the same trainee ID “AA0001” as the personal training menu 502 that is the first personal training menu, from the sensor data retained by the sensor data management unit 208 (step S1304).

Next, the training effect status acquisition unit 213 calculates the training effect amount in the implementation period of the first personal training menu (step S1305). In the present embodiment, a description is given using the amount of increase/decrease in body weight as the training effect amount.

First, to begin, the training effect amount of the personal training is obtained, and next the training effect amount of the content is obtained.

In a case where the amount of increase/decrease in body weight is used as the training effect amount, the training effect amount of the personal training is calculated with the following numerical formula.

Training effect amount of personal training=(most recent body weight)−(most recent body weight prior to implementation period of personal training menu)

Since the most recent body weight is “75.2”, and the most recent body weight prior to the personal training implementation period is a body weight of “75.0” as of Feb. 28, 2015, the training effect amount of the personal training is “0.2”.

Next, the training effect status acquisition unit 213 calculates the training effect amount of each item of content (step S1306).

The training effect status acquisition unit 213 calculates a training effect amount for each item of content, and therefore has to acquire the training history 601, which is the training history having the same trainee ID as “AA0001”, namely the trainee ID of the first personal training menu.

The training effect amount of specific content is calculated with the following numerical formula, and it is necessary for the following numerical formula to be used to calculate the training effect amount for all content making up the personal training menu.

Training effect of specific content=(implementation count of specific content within implementation period)/(implementation count of all content within implementation period)×(effect amount of personal training)

There is only one item of content, “Yoga 1”, making up the personal training menu 502, and therefore the training effect of specific content is acquired for “Yoga 1”.

Reference is made to the training history 601, and the implementation count of “Yoga 1” from Mar. 1, 2015 to Mar. 7, 2015, which is the implementation period, is “2”, the implementation count of all content is “2”, and the personal training effect amount is 0.2, and therefore the training effect of the “Yoga 1” content is “0.2”.

It should be noted that in a case where there is only one item of content making up the personal training, the training effect amount and the training effect of the specific content are equal, and therefore the calculation processing may be omitted.

Next, the training effect status acquisition unit 213 uses the effect level mapping table 1401 to establish that the training effect “0.2”, for which the effect level was acquired from the training effect amount (step S1307), is within the range of 0 kg or more to less than +0.5 kg, and therefore that the effect level is “D”.

Next, with respect to the training status table created in step S1002, the training effect status acquisition unit 213 inputs “D”, which is the value of the effect level value calculated in step S1307, into the effect level section of the training implementation status table 1220, which is the training status table having the same trainee ID “AA0001” (step S1308). Thus, a training implementation status table 1501 is formed.

Next, the training effect status acquisition unit 213 increments the value of N by 1, and processing returns to step S1302 (step S1309).

Similarly, the training implementation status table 1221 is updated to a training implementation status table 1502 from the personal training menu 503, the training history 602, the sensor data 702, and the effect level mapping table 1401. The training implementation status table 1222 is updated to a training implementation status table 1503 from the personal training menu 504, the training history 603, the sensor data 703, and the effect level mapping table 1401. In this way, the training implementation status tables of all trainees are updated and processing is terminated.

Here, we will return to the flowchart of FIG. 11. Next, the training menu update control unit 210 instructs the content demand calculation unit 214 to calculate content demand. The content demand calculation unit 214 calculates content demand (step S1004).

Here, the flow of the content demand calculation will be described using the flowchart of FIG. 19, the member information 301 of FIG. 3, the content categorizing table 1200 of FIG. 13, and the training implementation status tables 1501, 1502, and 1503 of FIG. 18.

To begin, the content demand calculation unit 214 assigns “1” to the variable N (step S1600).

The content demand calculation unit 214 refers to the member information 301 retained by the member information management unit 201, and determines whether or not there is a first trainee (step S1601).

Since the determination result of step S1601 is “yes”, the content demand calculation unit 214 refers to the training implementation status table 1501 of the trainee having the trainee ID “AA0001”, who is the first trainee, and determines whether or not there is a data row in the training implementation status table from within the implementation period (step S1602).

Since the determination result is “yes” in step S1602 and there is a data row 1511 from within the implementation period, the content demand calculation unit 214 acquires the training implementation status table 1501 from within the implementation period for the first trainee (step S1603).

Next, the content demand calculation unit 214 assigns “1” to the variable M (step S1604).

Next, the content demand calculation unit 214 determines whether or not there is first content in the data row 1511 of the training status table from within the implementation period (step S1605).

Since the determination result is “yes” in step S1605 and “Yoga 1” constituting the first content is present, the content demand calculation unit 214 refers to the data row 1511 of the training status table from within the implementation period, and determines whether or not the implementation rate of “Yoga 1” constituting the first content is less than the threshold value (step S1606). Here, the threshold value is taken as 50%, and it is determined whether or not the implementation rate is less than 50%.

Since the implementation rate is “43(%)” and the determination result is “yes” in step S1606, the content demand calculation unit 214 refers to the content categorizing table 1200, which is the content categorization result of step S1001, and a data row 1510 of the training implementation status table from prior to the implementation period, and determines whether or not there is (1) content having an implementation rate that is equal to or greater than a threshold value, or (2) content that has not been implemented, in the same category as “Yoga 1”, which is the first content (step S1607). Here, the threshold value is taken as 50%, and it is determined whether or not there is content that has an implementation rate of 50% or greater or has not been implemented.

When the content demand calculation unit 214 refers to the content categorizing table 1200, “Muscle Training 1” is present as content other than “Yoga 1” in the same category as “Yoga 1”, which is the first content, and therefore the content demand calculation unit 214 refers to the data row 1510 of the training implementation status table from prior to the implementation period, and determines whether the implementation rate of “Muscle Training 1” is equal to or greater than 50%, or whether “Muscle Training 1” has not been implemented, in other words, whether a training implementation status for “Muscle Training 1” is not present. When reference is made to the data row 1510 of the training implementation status table, the implementation rate of “Muscle Training 1” is “14(%)”, and therefore the determination result is “no”.

Since the determination result is “no” in step S1607, the content demand calculation unit 214 increments, by 1, the value of “content demand” for a category in which the strengthening region is the “upper body” and the exercise intensity is “1”, namely a category including the first content, of the content categorizing table 1200, and processing advances to step S1612 (step S1608).

Next, the content demand calculation unit 214 increments the value of the variable M by 1 to “2”, and processing returns to step S1605 (step S1612).

Next, the content demand calculation unit 214 determines whether or not there is second content in the data row 1511 of the training status table from within the implementation period (step S1605).

Since the determination result is “no”, processing advances to step S1613.

Next, the content demand calculation unit 214 increments the value of the variable N by 1 to “2”, and processing returns to step S1601.

Next, the content demand calculation unit 214 refers to the member information retained by the member information management unit 201, and determines whether or not there is a second trainee (step S1601).

Since the determination result is “yes”, the content demand calculation unit 214 refers to the training implementation status table 1502 of the trainee having the trainee ID “AA0002”, who is the second trainee, and determines whether or not there is a data row in the training implementation status table from within the implementation period (step S1602).

Since the determination result is “yes” in step S1602 and there is a data row 1512 in the training implementation status table from within the implementation period, the content demand calculation unit 214 acquires the training implementation status table 1502 from within the implementation period for the second trainee (step S1603).

Next, “1” is assigned to the variable M (step S1604). Next, the content demand calculation unit 214 determines whether or not there is first content in the data row 1512 of the training status table from within the implementation period (step S1605).

Since the determination result is “yes” in step S1605 and “Yoga 4” constituting the first content is present, the content demand calculation unit 214 refers to the data row 1512 of the training status table from within the implementation period, and determines whether or not the implementation rate of the first content is less than the threshold value (step S1606). Here, the threshold value is taken as 50%, and it is determined whether or not the implementation rate is less than 50%.

Since the implementation rate of “Yoga 4” constituting the first content is “71(%)”, the determination result is “no”.

Since the determination result is “no” in step S1606, the content demand calculation unit 214 refers to the data row 1512 of the training status table from within the implementation period, and determines whether or not the effect level of the first content is C or greater (step S1609).

Since the effect level of “Yoga 4” constituting the first content is “C”, the determination result is “yes”.

Processing advances to step S1612 since the determination result is “yes”, and the content demand calculation unit 214 increments the value of the variable M by 1 to 2, and processing returns to step S1605 (step S1612).

Next, the content demand calculation unit 214 determines whether or not there is second content in the data row 1512 of the training status table from within the implementation period (step S1605).

Since the determination result is “no”, processing advances to step S1613.

Next, the content demand calculation unit 214 increments the value of the variable N by 1 to “3”, and processing returns to step S1601.

The content demand calculation unit 214 refers to the member information retained by the member information management unit 201, and determines whether or not there is a third trainee (step S1601).

Since the determination result of step S1601 is “yes”, the content demand calculation unit 214 refers to the training implementation status table 1503 of the trainee having the trainee ID “AA0003”, who is the third trainee, and determines whether or not there is a data row in the training implementation status table from within the implementation period (step S1602).

Since the determination result is “yes” and there is a data row 1513 in the training implementation status table from within the implementation period, the content demand calculation unit 214 acquires the training implementation status table 1503 from within the implementation period for the third trainee (step S1603).

Next, the content demand calculation unit 214 assigns “1” to the variable M (step S1604).

Next, the content demand calculation unit 214 determines whether or not there is first content in the data row of the training status table from within the implementation period (step S1605).

Since the determination result is “yes” and “Muscle Training 4” constituting the first content is present, reference is made to the data row 1513 of the training status table from within the implementation period, and it is determined whether or not the implementation rate of the first content is less than the threshold value (step S1606). Here, the threshold value is taken as 50%, and it is determined whether or not the implementation rate is less than 50%.

Since the implementation rate of “Muscle Training 4” constituting the first content is “71(%)”, the determination result is “no”.

In a case where the determination result was “no” in step S1606, the content demand calculation unit 214 refers to the data row 1513 of the training status table from within the implementation period, and determines whether or not the effect level of the first content is within the range of A to C (step S1609).

Since the effect level of “Muscle Training 4” constituting the first content is “D”, the determination result is “no”.

Since the determination result is “no” in step S1609, the content demand calculation unit 214 refers to the content categorizing table 1200, which is the content categorization result of step S1001, refers to data rows of the training implementation status table from prior to the implementation period, and determines whether or not there is (1) content having an implementation rate that is equal to or greater than a threshold value, or (2) content that has not been implemented, in the category one level above the first content (step S1610). Here, the threshold value is taken as 50%, and it is determined whether or not the implementation rate is equal to or greater than 50%.

Since the strengthening region is the “lower body” and the exercise intensity is “2” for the first content “Muscle Training 4”, the strengthening region is the “lower body” and the exercise intensity is “3” in the category one level above; however, since content belonging to the category in question is not present, the determination result is “no”.

Since the determination result of step S1610 is “no”, the content demand calculation unit 214 increments, by 1, the value of “content demand” for an exercise intensity of “2” with the strengthening region being the “lower body”, which is the category one level above the category of “Muscle Training 4”, namely the category of the first content in the content categorizing table 1200, and processing advances to step S1612 (step S1611).

Next, the content demand calculation unit 214 increments the value of the variable M by 1 to “2”, and processing returns to step S1605 (step S1612).

Next, the content demand calculation unit 214 determines whether or not there is second content in the data row 1513 of the training status table from within the implementation period (step S1605).

Since the determination result is “yes” and the second content “Yoga 1” is present, the content demand calculation unit 214 refers to the data row 1513 of the training status table from within the implementation period, and determines whether or not the implementation rate of the second content is less than the threshold value (step S1606). Here, the threshold value is taken as 50%, and it is determined whether or not the implementation rate is less than 50%.

Since the implementation rate of “Yoga 1” constituting the second content is “29(%)”, the determination result is “yes”.

Since the determination result of step S1606 is “yes”, the content demand calculation unit 214 refers to the content categorizing table that is the content categorization result of step S1001, and data rows of the training implementation status table from prior to the implementation period, and determines whether or not there is content that (1) has an implementation rate that is equal to or greater than a threshold value or (2) has not been implemented, in the same category as the second content (step S1607). Here, the threshold value is taken as 50%, and it is determined whether or not there is content that has an implementation rate of 50% or greater or has not been implemented.

The strengthening region is the “upper body” and the exercise intensity is “1” in “Yoga 1” constituting the second content, and “Muscle Training 1” is present in the same category. A training status from prior to the implementation period is not present. Therefore, since (1) content having an implementation rate that is equal to or greater than the threshold value is present, or “Muscle Training 1” is present as content that has not been implemented, in the same category as the second content, the determination result is “yes”.

Processing advances to step S1612 since the determination result is “yes”, and the content demand calculation unit 214 increments the value of the variable M by 1 to 3, and processing returns to step S1605 (step S1612).

Next, the content demand calculation unit 214 determines whether or not there is third content in the data row 1513 of the training status table from within the implementation period (step S1605).

Since the determination result is “no”, processing advances to step S1613. Next, the value of the variable N is incremented by 1 to “4”, and processing returns to step S1601.

Next, the content demand calculation unit 214 refers to the member information 301 retained by the member information management unit 201, and determines whether or not there is a fourth trainee (step S1601). Since the determination result is “no”, processing is terminated.

According to the aforementioned processing, categories in which there is a shortage of content are analyzed for all trainees, and the number of trainees for whom it is determined that there is a shortage of content in the category in question is input to the “content demand” section of the content categorizing table 1200, thereby generating a content categorizing table 1701.

Here, we will return to the flowchart of FIG. 11. Next, the training menu update control unit 210 notifies the result of the content demand calculation to the control unit 216. The control unit 216 notifies the content demand calculation result to the device 102 via the communication unit 209, and thereby notifies the content demand calculation result to the trainer (step S1005).

The content demand calculation result is, for example, the content categorizing table 1701 or the like obtained by content demand values having been input to a content categorizing table.

Furthermore, a content categorizing table rearranged in a ranking format from categories having a high content demand may be used.

The trainer 101 refers to the content demand calculation result and determines whether or not content should be additionally produced, and additionally produces content and registers the content in a case where it is determined that content should be additionally produced.

It should be noted that in a case where it is determined that the additional production of content is not necessary as a result of referring to the content demand calculation result, or in a case where the additional production of content is necessary but the trainer does not have the time to do so, content is not additionally produced. In such a case, step S1006 and step S1007 are skipped and processing advances to step S1008.

In the present embodiment, a description is given using an example in which the trainer additionally produces content having a title of “Muscle Training 6”, a genre of “muscle training”, an exercise intensity of “3”, a strengthening region of the “lower body”, and a proficiency of “2” and registers this content.

Here, we will return to the flowchart of FIG. 11. Next, the video management unit 202 receives the registration of content additionally produced by the trainer (step S1006).

When the trainer uses the device 102 to register the content having a title of “Muscle Training 6”, a genre of “muscle training”, an exercise intensity of “3”, a strengthening region of the “lower body”, and a proficiency of “2”, the control unit 216 registers data for distribution of the content in the video management unit 202, and additionally registers metadata of the content in video metadata information of the video meta-management unit 203.

FIG. 24 is video metadata information 2101 from after “Muscle Training 6” has been additionally registered.

Here, we will return to the flowchart of FIG. 11. Next, when the reception of content registration has been completed, the control unit 216 notifies the training menu update control unit 210 that the reception of content registration has been completed. The training menu update control unit 210 instructs the content categorizing unit 211 to categorize content, and the content categorizing unit 211 once again categorizes content including the content additionally registered in step S1006 (step S1007).

The result of once again categorizing content including “Muscle Training 6”, which is the content registered in step S1006, is a content categorizing table 1800.

Next, the training menu update control unit 210 instructs the training menu alteration unit 215 to alter the personal training menu, and the training menu alteration unit 215 alters the personal training menu (step S1008).

Here, the flow of the personal training menu alteration will be described using the flowchart of FIG. 22, the member information 301 of FIG. 3, the content categorizing table 1800 of FIG. 21, and the training implementation status tables 1501, 1502, and 1503 of FIG. 18.

To begin, the content demand calculation unit 214 assigns “1” to the variable N (step S1600).

The content demand calculation unit 214 refers to the member information 301 retained by the member information management unit 201, and determines whether or not there is a first trainee (step S1601).

Since the determination result of step S1601 is “yes”, the content demand calculation unit 214 refers to the training implementation status table 1501 of the trainee having the trainee ID “AA0001”, who is the first trainee, and determines whether or not there is a data row in the training implementation status table from within the implementation period (step S1602).

Since the determination result is “yes” in step S1602 and there is a data row 1511 from within the implementation period, the content demand calculation unit 214 acquires the training implementation status table 1501 from within the implementation period for the first trainee (step S1603).

Next, the content demand calculation unit 214 assigns “1” to the variable M (step S1604).

Next, the content demand calculation unit 214 determines whether or not there is first content in the data row 1511 of the training status table from within the implementation period (step S1605).

Since the determination result is “yes” in step S1605 and “Yoga 1” constituting the first content is present, the content demand calculation unit 214 refers to the data row 1511 of the training status table from within the implementation period, and determines whether or not the implementation rate of “Yoga 1” constituting the first content is less than the threshold value (step S1606). Here, the threshold value is taken as 50%, and it is determined whether or not the implementation rate is less than 50%.

Since the implementation rate is “43(%)” and the determination result is “yes” in step S1606, the content demand calculation unit 214 refers to the content categorizing table 1800, which is the content categorization result of step S1007, and the data row 1510 of the training implementation status table from prior to the implementation period, and determines whether or not there is (1) content having an implementation rate that is equal to or greater than a threshold value, or (2) content that has not been implemented, in the same category as “Yoga 1”, which is the first content (step S1802). Here, the threshold value is taken as 50%, and it is determined whether or not there is content that has an implementation rate that is equal to or greater than 50% or has not been implemented.

When reference is made to the content categorizing table 1800, “Muscle Training 1” is present as content other than “Yoga 1” in the same category as “Yoga 1”, which is the first content, and therefore the content demand calculation unit 214 refers to the data row 1510 of the training implementation status table from prior to the implementation period, and determines whether the implementation rate of “Muscle Training 1” is equal to or greater than 50%, or whether “Muscle Training 1” has not been implemented, in other words, whether a training implementation status for “Muscle Training 1” is not present. When reference is made to the data row 1510 of the training implementation status table, the implementation rate of “Muscle Training 1” is “14(%)”, and therefore the determination result is “no”.

Processing advances to step S1612 since the determination result is “no” in step S1607, and the content demand calculation unit 214 increments the value of the variable M by 1 to 2, and processing returns to step S1605 (step S1612).

Next, the content demand calculation unit 214 determines whether or not there is second content in the data row 1511 of the training status table from within the implementation period (step S1605).

Since the determination result is “no”, processing advances to step S1806.

Next, the content demand calculation unit 214 increments the implementation period of the personal training menu by an amount corresponding to the implementation period (step S1806).

The implementation period of the personal training menu 502 for the first trainee is one week from Mar. 1, 2015 to Mar. 7, 2015, and therefore the value obtained by incrementing by an amount corresponding to the implementation period becomes Mar. 8, 2015 to Mar. 14, 2015. Therefore, the implementation period of the personal training menu 502 for the first trainee is altered to “Mar. 8, 2015 to Mar. 14, 2015”.

Next, the content demand calculation unit 214 increments the value of the variable N by 1 to “2”, and processing returns to step S1601.

According to the aforementioned processing, the personal training menu 502 of the trainee having the trainee ID “AA0001” is updated, and a personal training menu 2002 is generated.

Next, the content demand calculation unit 214 refers to the member information retained by the member information management unit 201, and determines whether or not there is a second trainee (step S1601).

Since the determination result is “yes”, the content demand calculation unit 214 refers to the training implementation status table 1502 of the trainee having the trainee ID “AA0002”, who is the second trainee, and determines whether or not there is a data row in the training implementation status table from within the implementation period (step S1602).

Since the determination result is “yes” in step S1602 and there is a data row 1512 in the training implementation status table from within the implementation period, the content demand calculation unit 214 acquires the training implementation status table 1502 from within the implementation period for the second trainee (step S1603).

Next, “1” is assigned to the variable M (step S1604). Next, the content demand calculation unit 214 determines whether or not there is first content in the data row 1512 of the training status table from within the implementation period (step S1605).

Since the determination result is “yes” in step S1605 and “Yoga 4” constituting the first content is present, the content demand calculation unit 214 refers to the data row 1512 of the training status table from within the implementation period, and determines whether or not the implementation rate of the first content is less than the threshold value (step S1606). Here, the threshold value is taken as 50%, and it is determined whether or not the implementation rate is less than 50%.

Since the implementation rate of “Yoga 4” constituting the first content is “71(%)”, the determination result is “no”.

Since the determination result is “no” in step S1606, the content demand calculation unit 214 refers to the data row 1512 of the training status table from within the implementation period, and determines whether or not the effect level of the first content is C or greater (step S1803).

Since the effect level of “Yoga 4” constituting the first content is “C”, the determination result is “yes”.

Processing advances to step S1612 since the determination result is “yes”, and the content demand calculation unit 214 increments the value of the variable M by 1 to 2, and processing returns to step S1605 (step S1612).

Next, the content demand calculation unit 214 determines whether or not there is second content in the data row 1512 of the training status table from within the implementation period (step S1605).

Since the determination result is “no”, processing advances to step S1806.

Next, the content demand calculation unit 214 increments the implementation period of the personal training menu by an amount corresponding to the implementation period (step S1806).

The implementation period of the personal training menu 503 for the second trainee is one week from Mar. 1, 2015 to Mar. 7, 2015, and therefore the value obtained by incrementing by an amount corresponding to the implementation period becomes Mar. 8, 2015 to Mar. 14, 2015. Therefore, the implementation period of the personal training menu 503 for the second trainee is altered to “Mar. 8, 2015 to Mar. 14, 2015”.

Next, the content demand calculation unit 214 increments the value of the variable N by 1 to “3”, and processing returns to step S1601.

According to the aforementioned processing, the personal training menu 503 of the trainee having the trainee ID “AA0002” is updated, and a personal training menu 2003 is generated.

The content demand calculation unit 214 refers to the member information retained by the member information management unit 201, and determines whether or not there is a third trainee (step S1601).

Since the determination result of step S1601 is “yes”, the content demand calculation unit 214 refers to the training implementation status table 1503 of the trainee having the trainee ID “AA0003”, who is the third trainee, and determines whether or not there is a data row in the training implementation status table from within the implementation period (step S1602).

Since the determination result is “yes” and there is the data row 1513 in the training implementation status table from within the implementation period, the content demand calculation unit 214 acquires the training implementation status table 1503 from within the implementation period for the third trainee (step S1603).

Next, the content demand calculation unit 214 assigns “1” to the variable M (step S1604).

Next, the content demand calculation unit 214 determines whether or not there is first content in the data row of the training status table from within the implementation period (step S1605).

Since the determination result is “yes” and “Muscle Training 4” constituting the first content is present, the content demand calculation unit 214 refers to the data row 1513 of the training status table from within the implementation period, and determines whether or not the implementation rate of the first content is less than the threshold value (step S1606). Here, the threshold value is taken as 50%, and it is determined whether or not the implementation rate is less than 50%.

Since the implementation rate of “Muscle Training 4” constituting the first content is “71(%)”, the determination result is “no”.

In a case where the determination result was “no” in step S1606, the content demand calculation unit 214 refers to the data row 1513 of the training status table from within the implementation period, and determines whether or not the effect level of the first content is within the range of A to C (step S1803).

Since the effect level of “Muscle Training 4” constituting the first content is “D”, the determination result is “no”.

Since the determination result is “no” in step S1803, reference is made to the content categorizing table 1800, which is the result of once again categorizing content after registering content in step S1007, reference is made to data rows of the training implementation status table from prior to the implementation period, and it is determined whether or not there is (1) content having an implementation rate that is equal to or greater than a threshold value, or (2) content that has not been implemented, in the category one level above the first content (step S1804). Here, the threshold value is taken as 50%, and it is determined whether or not there is content that has an implementation rate of 50% or greater or has not been implemented.

Since the strengthening region is the “lower body” and the exercise intensity is “2” for the first content “Muscle Training 4”, the strengthening region is the “lower body” and the exercise intensity is “3” in the category one level above, and “Muscle Training 6” added due to step S1007 is present.

Furthermore, since there is no data row in the training implementation status table from prior to the implementation period, the determination result is “yes”.

Since the determination result of step S1804 is “yes”, the first content is altered to “Muscle Training 6” in the personal training menu 504 of the third trainee.

Next, the content demand calculation unit 214 increments the value of the variable M by 1 to “2”, and processing returns to step S1605 (step S1612).

Next, the content demand calculation unit 214 determines whether or not there is second content in the data row 1513 of the training status table from within the implementation period (step S1605).

Since the determination result is “yes” and the second content “Yoga 1” is present, the content demand calculation unit 214 refers to the data row 1513 of the training status table from within the implementation period, and determines whether or not the implementation rate of the second content is less than the threshold value (step S1606). Here, the threshold value is taken as 50%, and it is determined whether or not the implementation rate is less than 50%.

Since the implementation rate of “Yoga 1” constituting the second content is “29(%)”, the determination result is “yes”.

Since the determination result of step S1606 is “yes”, the content demand calculation unit 214 refers to the content categorizing table 1800, which is the result of once again categorizing content after registering content in step S1007, and to data rows of the training implementation status table from prior to the implementation period, and determines whether or not there is (1) content having an implementation rate that is equal to or greater than a threshold value, or (2) content that has not been implemented, in the same category as the second content (step S1801). Here, the threshold value is taken as 50%, and it is determined whether or not there is content that has an implementation rate of 50% or greater or has not been implemented.

The strengthening region is the “upper body” and the exercise intensity is “1” in “Yoga 1” constituting the second content, and “Muscle Training 1” is present in the same category. A training status from prior to the implementation period is not present. Therefore, since “Muscle Training 1” is present as content that has an implementation rate of 50% or greater or that has not been implemented in the same category as the second content, the determination result is “yes”.

Processing advances to step S1802 since the determination result is “yes”, and the content demand calculation unit 214 alters the second content to “Muscle Training 1” for the personal training menu 504 of the third trainee.

Next, the content demand calculation unit 214 increments the value of the variable M by 1 to “3”, and processing returns to step S1605 (step S1612).

Next, the content demand calculation unit 214 determines whether or not there is third content in the data row 1513 of the training status table from within the implementation period (step S1605).

Since the determination result is “no”, processing advances to step S1806.

The implementation period of the personal training menu 504 of the third trainee is one week from Mar. 1, 2015 to Mar. 7, 2015, and therefore the value obtained by incrementing by an amount corresponding to the implementation period becomes Mar. 8, 2015 to Mar. 14, 2015. Therefore, the implementation period of the personal training menu 504 of the third trainee is altered to “Mar. 8, 2015 to Mar. 14, 2015”.

Next, the content demand calculation unit 214 increments the value of the variable N by 1 to “4”, and processing returns to step S1601.

According to the aforementioned processing, the personal training menu 504 of the trainee having the trainee ID “AA0003” is updated, and a personal training menu 2004 is generated.

Next, the content demand calculation unit 214 refers to the member information 301 retained by the member information management unit 201, and determines whether or not there is a fourth trainee (step S1601). Since the determination result is “no”, processing is terminated.

According to the aforementioned personal training menu alteration processing, the personal training menus are altered for all trainees, and the personal training menu 2001 is generated.

As in the aforementioned personal training update processing, personal training menus are altered after content has been additionally produced according to a content demand calculation, and therefore content that is more suitable for the trainees is provided.

Furthermore, since the trainer knows how much demand there is for the content of each kind of category when altering a training menu, the trainer may create only content having a high demand, thereby reducing the workload of the trainer.

The present embodiment has been described using an online training service as an example; however, it should be noted that an online training system according to the present disclosure can be used for a service in which it is assumed that content used for training is added, updated, and deleted on a regular or non-regular basis in a training system in which the content is viewed and training is implemented, in other words, a service for lessons or the like for rehabilitation, sports training, or education.

In such a case, the retained training characteristics and sensor data may be altered according to the service.

For example, when applied in a rehabilitation service, content demand may be calculated by retaining a “rehabilitation region” indicating the region to be rehabilitated, a “rehabilitation degree” indicating the degree to which the rehabilitation region is to be rehabilitated and the rehabilitation content to be implemented at such time, or the like as training characteristics, retaining “muscle mass of rehabilitation region”, “grip strength”, or the like as sensor data, acquiring the training implementation status from the implementation count or the implementation rate of the rehabilitation training, and acquiring the training effect status from the “muscle mass of rehabilitation region”, “grip strength”, or the like.

For example, when applied in sports training, content demand may be calculated by retaining a “contest category”, an “exercise intensity” indicating the intensity of the exercise, or the like as training characteristics, retaining “lung capacity”, “100-meter time”, or the like as sensor data, acquiring the training implementation status from the implementation count or the implementation rate of the sports training, and acquiring the training effect status from the “lung capacity” or the “100-meter time”.

For example, when applied in a musical instrument lesson service as educational lessons, content demand may be calculated by retaining the “genre” of the music to be performed, “proficiency” indicating the skill required to perform the music, or the like as training characteristics, retaining the musical interval “accuracy” or the like as sensor data, acquiring the training implementation status from the training time or the like of the musical instrument lesson training, and acquiring the training effect status of the musical instrument lessons from the musical interval “accuracy” or the like.

It should be noted that the technique described in the aforementioned aspect can be realized in the following types of cloud services, for example. However, the types of cloud services with which the technique described in the aforementioned aspect is realized are not limited thereto.

### (Service Type 1: In-Company Data Center Type of Cloud Service)

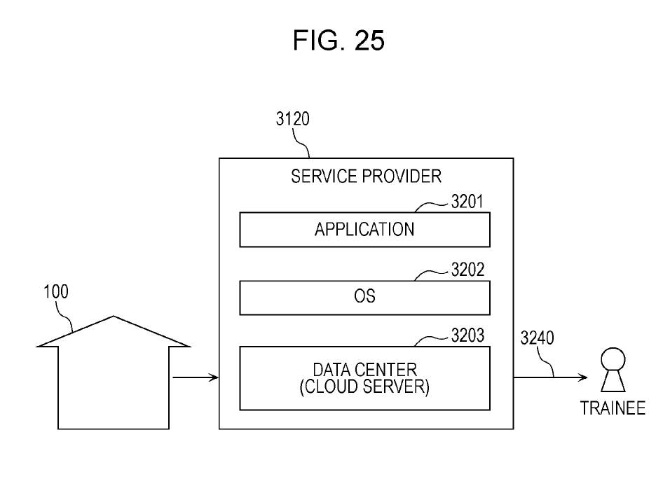

FIG. 25 is a drawing depicting an overall view of a service provided by an online coaching system of a service type 1 (in-company data center type of cloud service). In the present type, a service provider 3120 acquires information from the coaching group 100 and provides a service to a trainee. In the present type, the service provider 3120 has the functions of a data center operating company. In other words, the service provider 3120 possesses the cloud server 111, which manages big data. Consequently, there is no data center operating company.

In the present type, a data center (cloud server) 3203 performs operations and management in the service provider 3120. Furthermore, the service provider 3120 manages an operating system (OS) 3202 and an application 3201. The service provider 3120 uses the OS 3202 and the application 3201 managed by the service provider 3120 to provide a service (arrow 3204).

### (Service Type 2: IaaS Utilizing Type of Cloud Service)

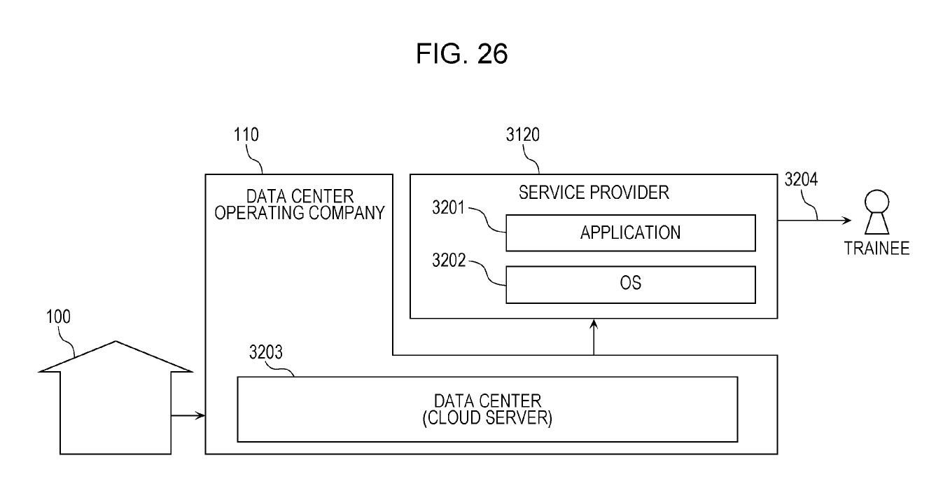

FIG. 26 is a drawing depicting an overall view of a service provided by an online coaching system of a service type 2 (IaaS utilizing type of cloud service). Here, IaaS is an abbreviation for infrastructure as a service, and is a cloud service provision model in which an infrastructure for constructing and operating a computer system is itself provided as a service via the Internet.

In the present type, the data center operating company 110 operates and manages the data center (cloud server) 3203. Furthermore, the service provider 3120 manages the OS 3202 and the application 3201. The service provider 3120 uses the OS 3202 and the application 3201 managed by the service provider 3120 to provide a service (arrow 3204).

### (Service Type 3: PaaS Utilizing Type of Cloud Service)

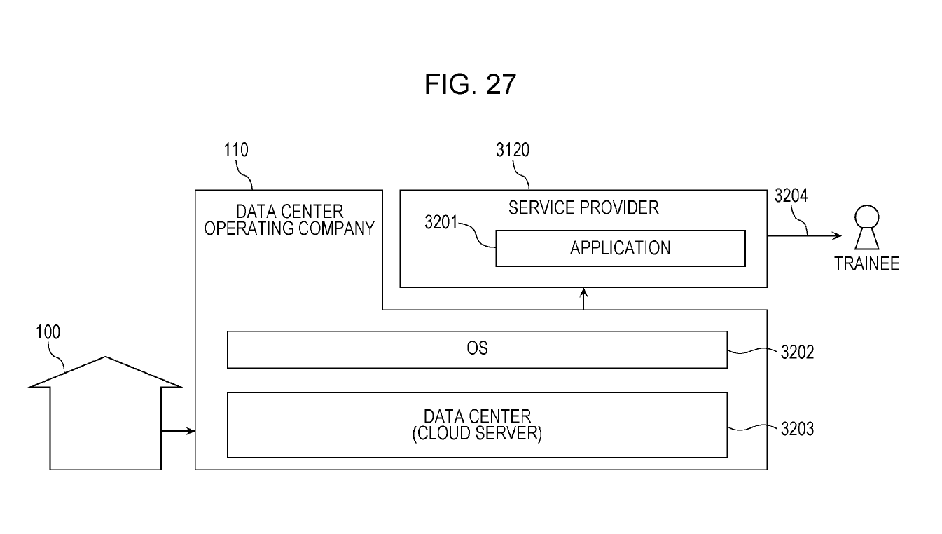

FIG. 27 is a drawing depicting an overall view of a service provided by an online coaching system of a service type 3 (PaaS utilizing type of cloud service). Here, PaaS is an abbreviation for platform as a service, and is a cloud service provision model in which a platform that is a foundation for constructing and operating software is provided as a service via the Internet.

In the present type, the data center operating company 110 manages the OS 3202 and operates and manages the data center (cloud server) 3203. Furthermore, the service provider 3120 manages the application 3201. The service provider 3120 uses the OS 3202 managed by the data center operating company 110 and the application 3201 managed by the service provider 3120 to provide a service (arrow 3204).

### (Service Type 4: SaaS Utilizing Type of Cloud Service)

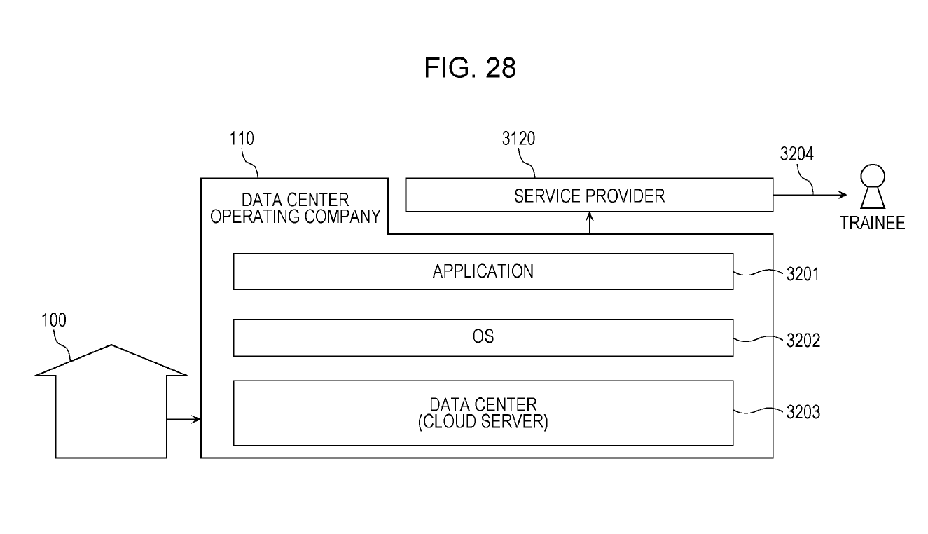

FIG. 28 is a drawing depicting an overall view of a service provided by an online coaching system of a service type 4 (SaaS utilizing type of cloud service). Here, SaaS is an abbreviation for software as a service and, for example, is a cloud service provision model that has a function with which it is possible for a company, an individual, or the like that does not possess a data center (cloud server) to use an application provided by a platform provider that does possess a data center (cloud server), via a network such as the Internet.

In the present type, the data center operating company 110 manages the application 3201, manages the OS 3202, and operates and manages the data center (cloud server) 3203. Furthermore, the service provider 3120 uses the OS 3202 and the application 3201 managed by the data center operating company 110 to provide a service (arrow 3204).

As described above, the service provider 3120 provides a service in all of the types of cloud service. Furthermore, for example, the development of an OS, an application, a database for big data, or the like may be implemented by the service provider or the data center operating company itself, and may be outsourced to a third party.

The online training system and the content provision support method according to the present disclosure are useful as an online coaching system and a content provision support method with which optimal content can be created at an optimal timing in a case where content used for training is added, updated, and deleted on a regular or non-regular basis. In other words, the present disclosure is useful for fitness, rehabilitation, and sports training systems, for example. Furthermore, the present disclosure can be used in a management-related manner, continuously, and repeatedly in an industry in which the aforementioned online system or the like is manufactured, sold, provided, and used.

What is claimed is:

1. A method used in a training system, comprising:
presenting content provided by a trainer to a trainee;
acquiring an implemented amount of a training implemented by the trainee in accordance with the presented content;
acquiring an effect amount indicating change in a body of the trainee caused by the training;
generating instruction information indicating new content to be provided by the trainer using the implemented amount and the effect amount; and
outputting the generated instruction information.

2. The method according to claim 1,
wherein the content is linked with a level of the training to be implemented based on the content,
in the generating, the implemented amount and the effect amount are used to decide the level of the training that is based on the new content, and
the instruction information includes the decided level.

3. The method according to claim 2, further comprising
calculating a degree of demand for the new content using the implemented amount and the effect amount,
wherein the instruction information includes the degree of demand for the new content.

4. The method according to claim 3, further comprising:
storing a plurality of items of the content provided by the trainer in the training system; and
calculating, the degree of demand for each of the stored content by increasing the degree of demand for content of training that is the same level as training based on the content in question in a case where:
(a) the implemented amount of the training based on the content in question is less than a prescribed value;
(b) the training system does not possess content of training that is the same level as the training based on the content in question and that has been implemented in an amount equal to or greater than a prescribed threshold value; and
(c) the training system does not possess content of training that is the same level as the training based on the content in question and that has not yet been implemented by the trainee.

5. The method according to claim 3, further comprising:
storing a plurality of items of the content provided by the trainer in the training system; and
calculating, the degree of demand for each of the stored content by increasing the degree of demand for content of a higher level than training based on the content in question in a case where:
(a) the implemented amount of the training based on the content in question is equal to or greater than a prescribed value;
(b) it is determined that the acquired effect amount satisfies a condition indicating that a prescribed effect is exhibited in the body of the trainee due to the training based on the content in question;
(c) the training system does not possess content of training that is of the higher level and has been implemented in an amount equal to or greater than a prescribed threshold value; and
(d) the training system does not possess content of training that is of the higher level and has not yet been implemented by the trainee.

6. The method according to claim 5,
wherein the content is linked with the category of the training implemented based on the content,
in the calculating, the plurality of items of content is grouped according to the category and level of the training based on the content in question, and
the training of the higher level for when the degree of demand is calculated is training of the same category as the training based on the content in question.

7. The method according to claim 1, further comprising:
storing the content provided by the trainer;
acquiring and storing the new content provided by the trainer in accordance with the output instruction information;
selecting content using the implemented amount and the effect amount from among the stored content and the stored new content; and
presenting a menu indicating the selected content to the trainee.

8. A server device in a training system comprising: one or more memories; and circuitry which, in operation:
presents content provided by a trainer to a trainee;
acquires an implemented amount of a training implemented by the trainee in accordance with the presented content;
acquires an effect amount indicating change in a body of the trainee caused by the training;
generates instruction information indicating new content to be provided by the trainer using the implemented amount and the effect amount; and
outputs the generated instruction information.
